(19) United States
(12) Patent Application Publication
(10) Pub. No.: US 2021/0404250 A1
(43) Pub. Date: Dec. 30, 2021

(54) Various Systems of Sculptural Slats and Methods of Manufacture Thereof

(71) Applicant: Bruce M. Werner, Jacksonville, FL (US)

(72) Inventor: Bruce M. Werner, Jacksonville, FL (US)

(21) Appl. No.: 17/398,144

(22) Filed: Aug. 10, 2021

Related U.S. Application Data
(63) Continuation-in-part of application No. 15/657,110, filed on Jul. 21, 2017, now abandoned.
(60) Provisional application No. 62/365,458, filed on Jul. 22, 2016.

(51) Int. Cl. E06B 9/386

(52) U.S. Cl. CPC E06B 9/386

(57) ABSTRACT

The present disclosure relates to sculptural slats, wherein varying orientations of sculptural slats within a sculptural slat structure may provide a range of one or both decorative or ambient variable impact. For example, sculptural slats may provide transitional states for a window covering, wherein if the covering is in an open position, the sculptural slat structure may provide an ambient variable impact, and wherein the ambient variable impact may change as the orientation of the sculptural slats is adjusted. In some aspects, the present disclosure provides variations on potential designs, smart technology integration, and applications to other types of slattable objects, including, for example, exterior and interior window coverings, architectural panels, dividers, screens; furniture; and automobiles components. Aftermarket solutions to upgrade traditional slatted structures and slattable objects are described, along with manufacturing methods to create customized sculptural slats and sculptural slat structures based on preferences, installation requirements, and slattable object.

### CROSS-REFERENCE TO RELATED APPLICATION

This application claims priority to and the full benefit of U.S. Nonprovisional patent application Ser. No. 15/657,110 (filed Jul. 21, 2017, and titled “VARIOUS SYSTEMS OF SCULPTURAL SLATS AND METHODS OF MANUFACTURE THEREOF”), which claimed priority to and the full benefit of United States Provisional Patent Application Ser. No. 62/365,458 (filed Jul. 22, 2016, and titled “VARIOUS SYSTEMS OF SCULPTURAL SLATS AND METHODS OF MANUFACTURE THEREOF”), the entire contents of which are incorporated in this application by reference.

### BACKGROUND OF THE DISCLOSURE

Traditionally, slats are incorporated in a variety of products and systems to manage and control exposure to sunlight, exposure to weather elements, visual privacy, sound transmission, air flow, temperature, physical security, or decorative aesthetics. These products and systems include blinds, shutters, shades, privacy screens, louvers, and doors.

Each of these products use a variety of different control systems. For example, a window blind may be made up of long horizontal strings held together by cords that run through the blind slats, often referred to as a string ladder. These blinds may then be manipulated, such as manually, with a remote, or by some other means, from an open position, with slats positioned and oriented to allow sunlight in, to a closed position where slats overlap and provide some of the benefits listed above.

Despite the decorative function of these products, which include window coverings, most are constricted to operating within a flat, two-dimensional plane. The current solutions on the market are limited to working within the framework of existing technology, or within the framework already provided by traditional solutions to mechanical restraints. Most have been constricted to the confines of the string ladder, limiting creativity and design sensibilities within that paradigm.

### SUMMARY OF THE DISCLOSURE

What is needed is a way to extend beyond the limits of a window covering's traditional solutions to mechanical constraints by providing structural support to do so while keeping the functionality of a covering. Accordingly, the present disclosure relates to sculptural slats, wherein varying orientations of the sculptural slats within a sculptural slat structure may provide a range of one or both decorative or ambient variable impact. For example, sculptural slats may provide transitional states for a window covering, wherein if the covering is in an open position, the sculptural slat structure may present a first set of characteristics, and wherein the set of characteristics may change as the orientation of the sculptural slats is adjusted.

In some aspects, the present disclosure provides variations on potential designs, smart technology integration, applications to other slat based products and systems, such as blinds, shutters, louvers, grills, vents, wall panels, ceiling panels, privacy screens, room dividers, shades, furniture, and automobiles, including whether the covering is indoor/outdoor or interior/exterior. Aftermarket solutions to upgrade coverings to the coverings described herein are similarly detailed, along with customization options for users to be able to create the slat-based products and systems described herein to their personal preferences.

The present disclosure relates to a sculptural slat that may include a first longitudinal end that may comprise at least one meandering profile; a first latitudinal end, where the first latitudinal end may be connected perpendicularly to the first longitudinal end; a second longitudinal end, where the second longitudinal end may be connected perpendicularly to the first latitudinal end and may be the distal end from the first longitudinal end; and a second latitudinal end, where the second latitudinal end may be connected perpendicularly to both the second longitudinal end and the first longitudinal end at opposing ends of the second latitudinal end.

In some implementations, the sculptural slat where the sculptural slat may comprise at least one integration mechanism. In some embodiments, the sculptural slat may comprise two or more layers. In some aspects, the incongruent ends of the top and bottom planar surface may connect at the first longitudinal end to form a meandering profile with variable thickness. In some embodiments, the surface of the sculptural slat may be asymmetric in three dimensions. In some implementations, the sculptural slat may comprise a variable thickness. In some aspects, the sculptural slat may comprise one or more layers that form the variable thickness. In some embodiments, the sculptural slat may be configured to insert onto a traditional slattable structure.

The present disclosure relates to a sculptural slat structure that may include a slattable object; a plurality of sculptural slats inserted in parallel within the slattable object, where each sculptural slat may comprise: a first longitudinal end may comprise at least one meandering profile; a first latitudinal end, where the first latitudinal end may be connected perpendicularly to the first longitudinal end; a second longitudinal end, where the second longitudinal end may be connected perpendicularly to the first latitudinal end and may be the distal end from the first longitudinal end; and a second latitudinal end, where the second latitudinal end may be connected perpendicularly to both the second longitudinal end and the first longitudinal end at opposing ends of the second latitudinal end. In some embodiments, the sculptural slat structure includes an integration mechanism connecting the plurality of sculptural slats to the slattable object.

In some implementations, the plurality of sculptural slats may comprise asymmetric meandering profiles of different lengths. In some aspects, the plurality of sculptural slats overlaps asymmetrically. In some embodiments, each of the plurality of sculptural slats may comprise a light source. In some implementations, each of the at least one meandering profiles may comprise a curvilinear, orthogonal, or rectilinear profile. In some aspects, the plurality of sculptural slats may comprise two or more asymmetric sculptural slat designs.

In some embodiments, each of the at least one meandering profiles may comprise a unique pattern. In some implementations, each of the plurality of sculptural slats are configured for a plurality of orientations within the slattable object. In some aspects, the plurality of orientations are controllable through the integration mechanism. In some embodiments, the plurality of orientations creates a plurality of ambient variable impact. In some implementations, each of the plurality of sculptural slats may comprise variable thickness. In some aspects, each of the second longitudinal end may comprise at least a second meandering profile.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1A illustrates an exemplary sculptural slat structure containing a series of sculptural slats, according to some embodiments of the present disclosure.

FIG. 1B illustrates an exemplary cross-sectional side view of sculptural slat structure with a series of sculptural slats, according to some embodiments of the present disclosure.

FIG. 1C illustrates an exemplary sculptural slat, according to some embodiments of the present disclosure.

FIG. 1D illustrates an exemplary slattable object, according to some embodiments of the present disclosure.

FIG. 2A illustrates a top view of an exemplary sculptural slat with a continuous surface, according to some embodiments of the present disclosure.

FIG. 2B illustrates a side view of an exemplary sculptural slat with a continuous surface, according to some embodiments of the present disclosure.

FIG. 2C illustrates a perspective view of an exemplary sculptural slat with a variable surface, according to some embodiments of the present disclosure.

FIG. 2D illustrates a top view of an exemplary sculptural slat with a variable surface, according to some embodiments of the present disclosure.

FIG. 2E illustrates a side view of an exemplary sculptural slat with a variable surface, according to some embodiments of the present disclosure.

FIG. 2F illustrates a side view of an exemplary sculptural slat with a variable surface, according to some embodiments of the present disclosure.

FIG. 3 illustrates a side view of an exemplary sculptural slat with a variable thickness, according to some embodiments of the present disclosure.

FIG. 4A illustrates an exemplary series of variable sculptural slat designs, wherein the sculptural slat designs have substantially orthogonal profiles, according to some embodiments of the present disclosure.

FIG. 4B illustrates an exemplary series of variable sculptural slats separated individually, wherein the sculptural slat designs have substantially orthogonal profiles, according to some embodiments of the present disclosure.

FIG. 5A illustrates an exemplary series of variable sculptural slat designs, wherein the sculptural slat designs may comprise orthogonal profiles along their longitudinal edges, according to some embodiments of the present disclosure.

FIG. 5B illustrates an exemplary series of variable sculptural slat designs separated individually, wherein the sculptural slat designs comprises substantially different angular, non-rectilinear profiles along their longitudinal edges, according to some embodiments of the present disclosure.

FIG. 6A illustrates an exemplary series of variable sculptural slat designs, wherein the sculptural slat designs comprise one or more curvilinear, non-rectilinear profiles along their longitudinal edges, according to some embodiments of the present disclosure.

FIG. 6B illustrates an exemplary series of variable sculptural slats separated individually, wherein the sculptural slat designs comprise one or more curvilinear, non-rectilinear profiles along two of their longitudinal edges, according to some embodiments of the present disclosure.

FIG. 6C illustrates an exemplary series of sculptural slats with ambient variable impact and associated conditions that may cause the ambient variable impact, according to some embodiments of the present disclosure.

FIG. 6D illustrates an exemplary series of sculptural slats with ambient variable impact and associated conditions that may cause the ambient variable impact, according to some embodiments of the present disclosure.

FIG. 6E illustrates an exemplary series of sculptural slats with ambient variable impact and associated conditions that may cause the ambient variable impact, according to some embodiments of the present disclosure.

FIG. 6F illustrates an exemplary series of sculptural slats with ambient variable impact and associated conditions that may cause the ambient variable impact, according to some embodiments of the present disclosure.

FIG. 7A illustrates a front view of an exemplary series of variable sculptural slat designs, wherein a sculptural slat may comprise a light source that creates a glowing feature or provides an illuminated sculptural slat, according to some embodiments of the present disclosure.

FIG. 7B illustrates an isometric view of a sculptural slat design, wherein the sculptural slat may comprise a light source that creates a glowing feature or provides an illuminated sculptural slat, according to some embodiments of the present disclosure.

FIG. 7C illustrates a side view of exemplary sculptural slats, indicating exemplary configurations as to how sculptural slats could host a light-source and how they may connect to one another, according to some embodiments of the present disclosure.

FIG. 7D illustrates a side view of alternative exemplary sculptural slats, indicating exemplary configurations as to how sculptural slats could host a light-source and how they may connect to one another, according to some embodiments of the present disclosure.

FIG. 7E illustrates an exemplary sculptural slat structure containing a series of sculptural slats wherein a sculptural slat may have a light source that creates a glowing feature or provides an illuminated sculptural slat, according to some embodiments of the present disclosure.

FIG. 8 illustrates an exemplary series of variable sculptural slat designs, according to some embodiments of the present disclosure.

FIG. 9A illustrates an exemplary method step for assembling a slattable object with multi-layered distinctive sculptural slat composites using conventional blinds parts, such as a head rail, bottom rail, string ladders, and pull cords, according to some embodiments of the present disclosure.

FIG. 9B illustrates an exemplary method step for assembling a slattable object with multi-layered distinctive sculptural slat composites using conventional blinds parts, such as a head rail, bottom rail, string ladders, and pull cords, according to some embodiments of the present disclosure.

FIG. 9C illustrates an exemplary method step for assembling a sculptural slat structure with multi-layered distinctive sculptural slat composites using conventional blinds parts, such as a head rail, bottom rail, string ladders, and pull cords, according to some embodiments of the present disclosure.

FIG. 9D illustrates an exemplary method step for assembling a sculptural slat structure with multi-layered distinctive sculptural slat composites using conventional blinds parts, such as a head rail, bottom rail, string ladders, and pull cords, according to some embodiments of the present disclosure.

FIG. 9E illustrates an exemplary method step for assembling a sculptural slat structure with multi-layered distinctive sculptural slat composites using conventional blinds parts, such as a head rail, bottom rail, string ladders, and pull cords, according to some embodiments of the present disclosure.

FIG. 9F illustrates a multi-layered sculptural slat joint within a sculptural slat composite that envelops a string ladder rung between a bottom layer and a top layer, wherein both layers may contain the string ladder or be contained within a string ladder, according to some embodiments of the present disclosure.

FIG. 9G illustrates a multi-layered sculptural slat joint within a sculptural slat composite that envelops a string ladder rung between a bottom layer and a top layer, wherein both layers may contain the string ladder or be contained within a string ladder, according to some embodiments of the present disclosure.

FIG. 9H illustrates a multi-layered sculptural slat joint within a sculptural slat composite that envelops a string ladder rung between a bottom layer and a top layer, wherein both layers may contain the string ladder or be contained within a string ladder, according to some embodiments of the present disclosure.

FIG. 9J illustrates a multi-layered sculptural slat joint within a sculptural slat composite that envelops a string ladder rung between a bottom layer and a top layer, wherein both layers may contain the string ladder or be contained within a string ladder, according to some embodiments of the present disclosure.

FIG. 10 illustrates an exemplary sculptural slat structure comprising a plurality of integration mechanisms, according to some embodiments of the present disclosure.

FIG. 11A illustrates an exemplary integration mechanism, according to some embodiments of the present disclosure.

FIG. 11B illustrates an exemplary integration mechanism, according to some embodiments of the present disclosure.

FIG. 11C illustrates an exemplary integration mechanism, according to some embodiments of the present disclosure.

FIG. 11D illustrates an exemplary integration mechanism, according to some embodiments of the present disclosure.

FIG. 12A illustrates an exemplary method step for a sculptural slat structure assembly wherein a sculptural slat depth is greater than the clear dimensions of a slattable object integration mechanism.

FIG. 12B illustrates an exemplary method step for a sculptural slat structure assembly wherein a sculptural slat depth is greater than the clear dimensions of a slattable object integration mechanism, according to some embodiments of the present disclosure.

FIG. 12C illustrates an exemplary method step for a sculptural slat structure assembly wherein a sculptural slat depth is greater than the clear dimensions of a slattable object integration mechanism, according to some embodiments of the present disclosure.

FIG. 12D illustrates an exemplary method step for a sculptural slat structure assembly wherein a sculptural slat depth is greater than the clear dimensions of a slattable object integration mechanism, according to some embodiments of the present disclosure.

FIG. 12E illustrates an exemplary method step for a sculptural slat structure assembly wherein a sculptural slat depth is greater than the clear dimensions of an integration mechanism, according to some embodiments of the present disclosure.

FIG. 12F illustrates an exemplary method step for a sculptural slat structure assembly wherein a sculptural slat depth is greater than the clear dimensions of an integration mechanism, according to some embodiments of the present disclosure.

FIG. 12G illustrates an exemplary method step for a sculptural slat structure assembly wherein a sculptural slat depth is greater than the clear dimensions of an integration mechanism, according to some embodiments of the present disclosure.

FIG. 13A illustrates an exemplary embodiment of a sculptural slat structure with variable sculptural slat designs.

FIG. 13B illustrates an exemplary embodiment of a sculptural slat structure with variable sculptural slat designs.

FIG. 13C illustrates an exemplary embodiment of a sculptural slat structure with variable sculptural slat designs.

FIG. 13D illustrates an exemplary embodiment of a sculptural slat structure with variable sculptural slat designs.

FIG. 14A illustrates exemplary embodiments of a sculptural slat structure with variable sculptural slat designs, wherein the sculptural slat designs have substantially different curvilinear, non-rectilinear profiles along their longitudinal edges, according to some embodiments of the present disclosure.

FIG. 14B illustrates exemplary embodiments of alternative coverings with variable sculptural slat designs, wherein the sculptural slat designs have substantially different curvilinear, non-rectilinear profiles along their longitudinal edges, according to some embodiments of the present disclosure.

FIG. 14C illustrates exemplary embodiments of alternative coverings with variable sculptural slat designs, wherein the sculptural slat designs have substantially different curvilinear, non-rectilinear profiles along their longitudinal edges, according to some embodiments of the present disclosure.

FIG. 15A illustrates exemplary embodiments of coverings relating to interior architecture with variable sculptural slat designs, wherein the sculptural slat designs have substantially different curvilinear, non-rectilinear profiles along their longitudinal edges, according to some embodiments of the present disclosure.

FIG. 15B illustrates exemplary embodiments of coverings relating to interior architecture with variable sculptural slat designs, wherein the sculptural slat designs have substantially different curvilinear, non-rectilinear profiles along their longitudinal edges, according to some embodiments of the present disclosure.

FIG. 15C illustrates exemplary embodiments of coverings relating to interior architecture with variable sculptural slat designs, wherein the sculptural slat designs have substantially different curvilinear, non-rectilinear profiles along their longitudinal edges, according to some embodiments of the present disclosure.

FIG. 16A illustrates exemplary alternative coverings that may use a series of sculptural slats, according to some embodiments of the present disclosure.

FIG. 16B illustrates exemplary alternative coverings that may use a series of sculptural slats, according to some embodiments of the present disclosure.

FIG. 16C illustrates exemplary alternative coverings that may use a series of sculptural slats, according to some embodiments of the present disclosure.

FIG. 17 illustrates exemplary embodiments of grills and vents with variable sculptural slat designs, wherein the sculptural slat designs have substantially different curvilinear, non-rectilinear profiles along their longitudinal edges, according to some embodiments of the present disclosure.

FIG. 18 illustrates exemplary embodiments of coverings relating to interior architecture that may use a series of sculptural slats, according to some embodiments of the present disclosure.

FIG. 19A illustrates exemplary embodiments of interior furniture that may use a series of sculptural slats, according to some embodiments of the present disclosure.

FIG. 19B illustrates exemplary embodiments of interior furniture that may use a series of sculptural slats, according to some embodiments of the present disclosure.

FIG. 20A illustrates exemplary embodiments of interior furniture with variable sculptural slat designs, wherein the sculptural slat designs have substantially different curvilinear, non-rectilinear profiles along their longitudinal edges, according to some embodiments of the present disclosure.

FIG. 20B illustrates exemplary embodiments of interior furniture with variable sculptural slat designs, wherein the sculptural slat designs have substantially different curvilinear, non-rectilinear profiles along their longitudinal edges, according to some embodiments of the present disclosure.

FIG. 21A illustrates exemplary embodiments of interior or exterior architectural coverings that may use a series of sculptural slats, according to some embodiments of the present disclosure.

FIG. 21B illustrates exemplary embodiments of exterior architectural coverings that may use a series of sculptural slats, according to some embodiments of the present disclosure.

FIG. 21C illustrates exemplary embodiments of exterior architectural coverings that may use a series of sculptural slats, according to some embodiments of the present disclosure.

FIG. 22A illustrates exemplary embodiments of interior or exterior architectural coverings with variable sculptural slat designs, wherein the sculptural slat designs have substantially different curvilinear, non-rectilinear profiles along their longitudinal edges, according to some embodiments of the present disclosure.

FIG. 22B illustrates exemplary embodiments of exterior architectural coverings with variable sculptural slat designs, wherein the sculptural slat designs have substantially different curvilinear, non-rectilinear profiles along their longitudinal edges, according to some embodiments of the present disclosure.

FIG. 22C illustrates exemplary embodiments of exterior architectural coverings with variable sculptural slat designs, wherein the sculptural slat designs have substantially different curvilinear, non-rectilinear profiles along their longitudinal edges, according to some embodiments of the present disclosure.

FIG. 23A illustrates an exemplary process flowchart for customizing and ordering sculptural slat structures, according to some embodiments of the present disclosure.

FIG. 23B illustrates an exemplary process flowchart for manufacturing customized sculptural slat structures, according to some embodiments of the present disclosure.

FIG. 23C illustrates an exemplary process flowchart for generating specifications for manufacturing sculptural slat structures, according to some embodiments of the present disclosure.

### DETAILED DESCRIPTION

The present disclosure relates to sculptural slats, wherein varying orientations of sculptural slats within a sculptural slat structure may provide a range of one or both decorative or ambient variable impact. For example, sculptural slats may provide transitional states for a window covering, wherein if the covering is in an open position, the sculptural slat structure may present a first set of characteristics, and wherein the set of characteristics may change as the orientation of the sculptural slats is adjusted.

In some aspects, the present disclosure provides variations on potential designs, smart technology integration, and applications to other types of slattable objects, including, for example, exterior and interior window coverings, architectural panels, dividers, and screens; furniture; and automobiles components. Aftermarket solutions to upgrade traditional slatted structures and slattable objects are described, along with manufacturing methods to create customized sculptural slats and sculptural slat structures based on preferences, installation requirements, and slattable object. In the following sections, detailed descriptions of examples and methods of the disclosure will be given.

The description of both preferred and alternative examples, though thorough, are exemplary only, and it is understood that to those skilled in the art that variations, modifications, and alterations may be apparent. It is therefore to be understood that the examples do not limit the broadness of the aspects of the underlying disclosure as defined by the claims.

### Glossary

Ambient Variable: as used herein, refers to an ambient characteristic that a sculptural slat and sculptural slat structure may affect. In some aspects, an ambient variable impact relates to the extent of the effect. In some implementations, ambient variables may include light, shadow, visual privacy, temperature, sound, air flow, moisture, or a combination.

Planar Sheet: as used herein, refers to a base shape for a sculptural slat, wherein a sculptural edge may provide detailing to at least one edge of the planar sheet. In some aspects, planar sheet may refer to multiple layers that may be combined to create a planar sheet. In some embodiments, a planar sheet may be manufactured through additive or subtractive manufacturing. In some implementations, a planar sheet may comprise a curved, angled, or irregular surface.

Sculptural slat: as used herein, refers to individual slats comprising one or more decorative characteristics and ambient variable impact, wherein at least one of those characteristics may be transitional based on the orientation of the sculptural slats within a sculptural slat structure. In some embodiments, those characteristics may control the ambient variable impact on one or both the first environment and the second environment. In some aspects, the ambient variable impact may be transitional, such as based on orientation of the sculptural slat, material of the sculptural slat, functional position of the sculptural slat, position of light sources in the environments, color of light sources, or intensity of the light sources, as non-limiting examples. For example, decorative characteristics may include color, shape, design, pattern, material, or size. For example, ambient variable impact may include light absorption, heat absorption, light reflection, shading, glow brightness, room darkening, sound dampening or amplification, air flow, temperature control, visual privacy, protection from dust, dirt, and particles. Sculptural slats may be arranged in a series, wherein a plurality of sculptural slats may combine, overlap, or fit into or onto each other to form a sculptural slat structure. In some embodiments, sculptural slats may be arranged in parallel layers within the sculptural slat structure. In some aspects, sculptural slats may be customized to the preferences of a customer, installation space, ambient variable impact, or other criteria.

Sculptural slat structure: as used herein, refers to a system of sculptural slats. In some aspects, a sculptural slat structure may comprise a traditionally slatted object including, for example, a window covering, including blinds, shutters, and louvers. In some aspects, a sculptural slat structure may be a modular system of sculptural slats that may be adhered, inserted, mechanically fastened, clipped, or converted to a slattable object.

Slattable object: as used herein, refers to a framework in which a sculptural slat or sculptural slat structure may be inserted into, added, adhered to, or combined with, including, but not limited to, a window covering, including blinds, shutters, louvers, shades, and other similar coverings; grills; vents; wall panels; ceiling panels; furniture, including, but not limited to, baskets, drawers, benches, tables, cribs, bassinets, bookcases, cabinets, shelves, and other similar furniture; building or architectural elements, including, but not limited to, louver doors; outdoor objects, including, but not limited to, fences, gates, trellises, arbors, pergola, planter, or raised garden boxes, and other similar objects; automotive structures and/or accessories, including, but not limited to, air conditioning vents, grills, and other similar structures and/or accessories; lap siding, panel siding, roof shingles, or other exterior cladding.

Integration Mechanism: as used herein, refers to a mechanism that may connect sculptural slats to a slattable object. In some aspects, an integration mechanism may be configured to manipulate the sculptural slats, such as to change orientation or to raise an entire sculptural slat structure. Examples of integration mechanism may include string ladders, bead chains, hooks, tilt bars, as non-limiting examples. In some aspects, the integration mechanism may be manual or automatic, such as driven by an electric motor.

Profile: as used herein, refers to an end of a planar surface. In some embodiments, the profile may comprise an intentional, non-linear shape that may provide a non-descript attribute to the sculptural slat such as aesthetics, efficiency, and efficacy of the intended functionality, as non-limiting examples. In some implementations, a profile may interface with another plane.

Meandering profile: as used herein, refers to the ends of a sculptural slat. The meandering profile may comprise one or more edges. In some embodiments, the edges of the planar surfaces of the sculptural slat may be orthogonal, angular, nonrectilinear, curvilinear, comprise an incongruent or asymmetrical pattern, or other non-limiting geometry. In some implementations, the joining of these edges may produce a profile of variable thickness.
Longitudinal and Latitudinal End: as used herein, refers to the four distal ends of a sculptural slat. In some embodiments, the longitudinal ends or latitudinal ends, or both, may comprise meandering profiles. In some implementations, the longitudinal ends or latitudinal ends, or both, may comprise variable thickness. In some aspects, the sculptural slat structure may align via at least one longitudinal or latitudinal end.

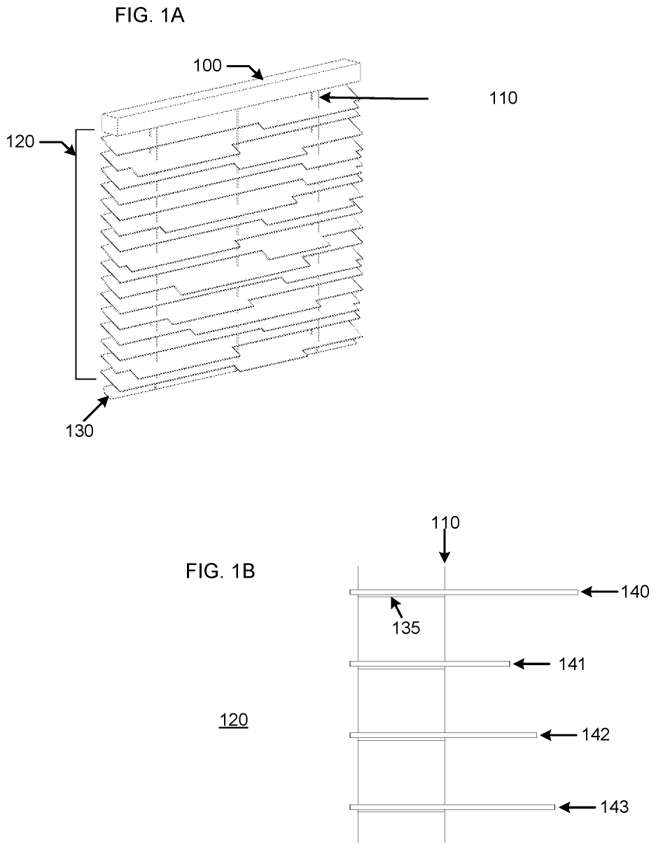

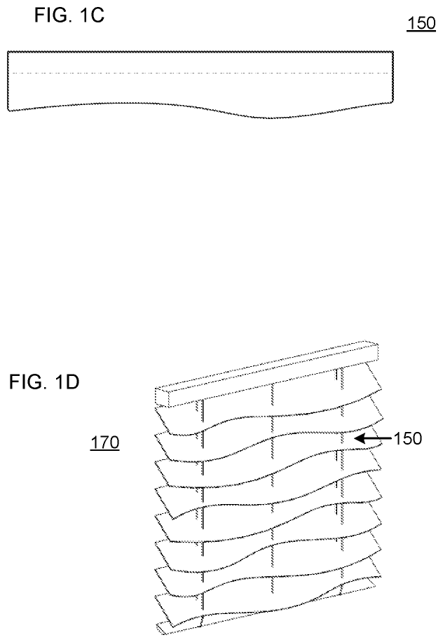

Referring now to FIG. 1A, exemplary sculptural slat structure containing a series of sculptural slats 120 is illustrated, wherein the sculptural slat structure may comprise a headrail 100, integration mechanism 110, a series of sculptural slats 120, and a bottom rail 130. In some aspects, a headrail 100 and bottom rail 130 may include, but not limited to, installation, support, and/or hold-down brackets, clips, plug sets, or a combination thereof. The specific mechanisms in the headrail 100 and bottom rail 130 may depend on one or both the functionality or design of the horizontal blind. In some aspects, the integration mechanism 110 may comprise a string ladder with lift cords.

In some embodiments, a series of sculptural slats 120 may include a pattern designed wherein the series of sculptural slats 120 may comprise a plurality of unique variations that may be installed in a pattern. In some implementations, the pattern may be asymmetrical and incongruent. In some embodiments, variations may be randomized, wherein a pattern may not be immediately obvious. In some implementations, a single sculptural slat within a series of sculptural slats 120 may consist of one extended layer. The extended layer may provide a nonlinear profile along a distal end of the sculptural slats 120. The nonlinear profile may comprise a variable thickness as the extended layer may protrude from a planar surface and connect to the end of another planar surface that extends to a different predetermined length.

In some aspects, a single sculptural slat within a series of sculptural slats 120 may comprise two or more layers stacked on top of each other. For example, a single sculptural slat may have one extended structural layer and one decorative layer attached on top. The difference in the contours of the layers may form a profile unique to the sculptural slat. In some embodiments, the curvilinear profile may exist along one or more latitudinal ends, longitudinal ends, or both. In some implementations, a single sculptural slat may include one extended structural layer and multiple decorative layers attached on top. In some aspects, multiple decorative layers may exist over multiple sculptural layers.

The unique profiles formed from the contours of the plurality of layers may be incongruous with the profiles of other sculptural slats 120. The resulting pattern of a plurality of sculptural slats 120 may be asymmetrical, nonrectilinear, incongruous, as non-limiting attributes.

In some embodiments, a series of sculptural slats 120 may consist of, but not limited to, polyvinyl chloride (PVC), plastic, aluminum, vinyl, wood, paperboard, paper, metal, felt, fabric, medium-density fibreboard (MDF), oriented strand board (OSB), ceramic tile, porcelain tile, fiber cement, asphalt, clay tile, polyester, concrete, glass, foam, cork, melamine, or a combination thereof. In some aspects, a series of sculptural slats 120 may be separately colored and/or stained along the front, back, in patterns, along thin edges, and/or in the interior or exterior of the material, wherein an interior of a material may be the same or different color or stain compared to the exterior. In some embodiments, there may be a color contrast between a pattern and main body of a sculptural slat. This color contrast may further differentiate a sculptural slat from surrounding sculptural slats. In some aspects, a nonlinear pattern may be generated from the incongruent compilation of unique sculptural slats.

In some implementations, a series of sculptural slats 120 may include colored edges. In some aspects, a single sculptural slat within a series of sculptural slats 120 may be composed of more than one material or color. In some implementations, a single sculptural slat may be composed of one material, though there may be sculptural slats with different materials and/or colors within a series of sculptural slats 120.

In some aspects, a series of sculptural slats 120 may interact with a tilt wand, tilt cord, or motorized tilt mechanism (not shown), to transition between orientations. In some implementations, a series of sculptural slats 120 may be manipulated by physical interaction to transition between orientations. In some aspects, a series of sculptural slats 120 may interact with a lift cord (not shown) to change its horizontal positioning. In some implementations, a series of sculptural slats 120 may interact with a cord equalizer (not shown) if needed. In some aspects, a series of sculptural slats 120 may interact with a one touch or cordless wandless system to change position and transition between orientations.

The modification of the horizontal positioning may further exemplify the meandering profile of the latitudinal ends of the sculptural slats. As an example, the latitudinal end of the meandering profile may comprise a nonrectilinear form intended to resemble the waves of the ocean. As the horizontal position of the sculptural slats is modified, light may accentuate the incongruent pattern of the sculptural slats by highlighting portions of the sculptural slats that may comprise a thinner, transparent material.

In some embodiments, the variable orientations may present transitioning views of the series of sculptural slats 120, wherein the transitioning views may comprise a range of one or both ornamental or ambient variable impact. In some aspects, the transitioning views may present different perspectives of the sculptural slats 120, wherein the variable orientations may present a unique overall appearance at each orientation. For example, the ornamental characteristics may comprise one or more colors, perceived geometry, or patterns. In some implementations, the transitioning views may present different ambient variable impact at each orientation. For example, the ambient variable impact may be one or more of light absorption, heat absorption, light reflection, glow brightness, shading, room darkening, sound dampening or amplification, air flow, temperature control, visual privacy, protection from dust, dirt, and particles, or other similar functionality according to some embodiments of the present disclosure.

As an illustrative example, at variable orientations, a series of sculptural slats 120 may present a range of perceived geometry and provide a range of light absorption. At a first orientation, such as a completely open orientation, the light absorption may be at a minimum, and the perceived geometry may comprise a series of jagged lines. At a second orientation, such as a completely closed, upward orientation, the light absorption may be at a maximum for the series of sculptural slats 120, and the perceived geometry may be comparable to a mountain range. The mountain range may demonstrate the incongruent profiles of the sculptural slats 120 that, together, form a design that originates from an asymmetrical design.

As another illustrative example, at variable orientations, a series of sculptural slats 120 may present a range of colors and provide a range of heat absorption. At a first orientation, such as a completely closed, upward orientation, the heat absorption may be at a maximum for the series of sculptural slats 120, and the color may be a deep purple to indicate that orientation may provide the coolest setting. At a second orientation, such as a completely open orientation, the heat absorption may be at a minimum, and the color may be a vibrant red to indicate the warmest setting. At a third orientation, such as a completely closed, downward orientation, the heat absorption may be somewhere in between the minimum and maximum heat absorption, and the color may be a light blue to indicate a moderate position within the range of heat absorption.

In some aspects, a series of sculptural slats 120 may interact with a device (not shown) to transition between orientations. In some aspects, a series of sculptural slats 120 may interact with a smart device (not shown) to transition between orientations. The smart device may include an application that controls certain aspects of a series of sculptural slats 120, including, but not limited to, remotely accessing sculptural slat functionality, changing orientation remotely, changing appearance of one or more sculptural slats in the series of sculptural slats 120, setting when a series of sculptural slats 120 change orientation, interacting with weather information in the cloud or with a smart device to adjust accordingly, and the like. In some aspects, a series of sculptural slats 120 may interact with the environment itself, changing depending on either pre-programmed or user programmed settings, such as changing orientation depending on outdoor or indoor temperature, exposure to sunlight, or based on user behavior or prior use.

In some embodiments, a series of sculptural slats 120 may be responsive to the functionality or use of where it is placed and may adjust according to a change depending on the use. In some implementations, a series of sculptural slats 120 may appear different depending on the opacity of the material it is comprised of, further altering its appearance depending on its orientation. For example, a series of sculptural slats 120 may alter its appearance, or be set to do so, if a particular location is used for work, play, or a general living space.

Referring now to FIG. 1B, an exemplary cross-sectional side view of sculptural slat structure with a series of sculptural slats 120 is illustrated, wherein the sculptural slat structure may comprise a series of sculptural slats 120, a: integration mechanism 110, and a sculptural slat support 135. A series of sculptural slats 120 may further comprise individual sculptural slats 140-143 composed of one or multiple layers.

In some embodiments, a series of individual sculptural slats 120 may rest on a sculptural slat support 135. In some implementations, one or more individual sculptural slats 140-143 may extend beyond the integration mechanism 110 and sculptural slat support 135. In some aspects, individual sculptural slats 140-143 may be of variable shapes, designs, widths, depths, segments, and layers. In some embodiments, the sculptural slats 140-143 may comprise a variable thickness that is unique to each sculptural slat 140-143.

As described in FIG. 1A, a series of sculptural slats 120 may comprise repeated variations of individual or unique slat designs. In some implementations, variations may be random, wherein a pattern may not be immediately obvious. In some implementations, a single sculptural slat 140 within a series of sculptural slats 120 may be made of one extended layer. In some aspects, a single sculptural slat within a series of sculptural slats 120 may comprise multiple stacked layers, which may be assembled and stabilized utilizing a range of connective mechanisms. In some embodiments, the stacked layers may form one or more meandering profiles along the longitudinal or latitudinal ends of the sculptural slat. For example, a single sculptural slat may have one extended structural layer and one decorative layer attached on top. In some implementations, the sculptural slats 120 may comprise a single sculptural slat 140 with one extended structural layer and multiple decorative layers attached on top.

As described in FIG. 1A, in some embodiments, a series of sculptural slats 120 may consist of, but not limited to, polyvinyl chloride (PVC), plastic, aluminum, vinyl, wood, paperboard, paper, metal, felt, fabric, medium-density fibs:): board (MDF), oriented strand board (OSB), ceramic tile, porcelain tile, fiber cement, asphalt, clay tile, polyester, concrete, glass, foam, cork, melamine, or a combination thereof. In some aspects, a series of sculptural slats 120 may be separately colored and/or stained along the front, back, in patterns, along thin edges, and/or in the interior or exterior of the material, so that if an interior of a material is a different color or stain compared to the exterior, there may be a color contrast between a pattern and main body of a sculptural slat. In some implementations, a series of sculptural slats 120 may include colored edges. In some aspects, a single sculptural slat within a series of sculptural slats 120 may be composed of more than one material or color. In some implementations, a series of sculptural slats 120 may comprise single sculptural slats of varying material or colors, wherein each sculptural slat may comprise multiple materials or colors, or various sculptural slats within the series of sculptural slats 120 may comprise different materials or colors.

In some implementations, a series of individual sculptural slats 120 may layer shapes of material on top of a main sculptural slat body. In some aspects, two or more patterns may overlap in a multi-layer sculptural slat to create a new blended pattern. In some embodiments, three-dimensional sculptural slats may be created by tone or more meandering profiles. In some implementations, a sculptural slat 140-143 may comprise a variable thicknesses, which may be achieved, for example, by additive or subtractive methods. In some aspects, the variable thickness and resultant three-dimensional sculptural slats may comprise meandering profiles along the latitudinal or longitudinal ends of the sculptural slats, or both.

In some embodiments, a sculptural slat support 135 may not have individual sculptural slats extended as shown in FIG. 1B. An after-market solution may be obtained to replicate the characteristics described in FIG. 1A. In such instances, a sculptural cover or sculptural slat extender may hold one or more layers that attach, adhere, affix, connect, couple, clip, bind, and/or latch, or some functional equivalent thereof, to existing products, to recreate the transitional functionality of the sculptural slats as described in FIG. 1A.

For example, with the addition, application, or installation of the after-market solution, one or both the decorative or ambient variable impact of a slattable object or standard or traditional slat system may adopt the decorative and ambient variable impact of the sculptural slat, wherein the characteristics may be adjusted through transitioning the series of sculptural slats 120 between orientations.

Referring now to FIG. 1C, an exemplary sculptural slat 150 is illustrated. Referring now to FIG. 1D, an exemplary sculptural slat structure 170 is illustrated, wherein the sculptural slat structure 170 comprises a series of sculptural slats 150.

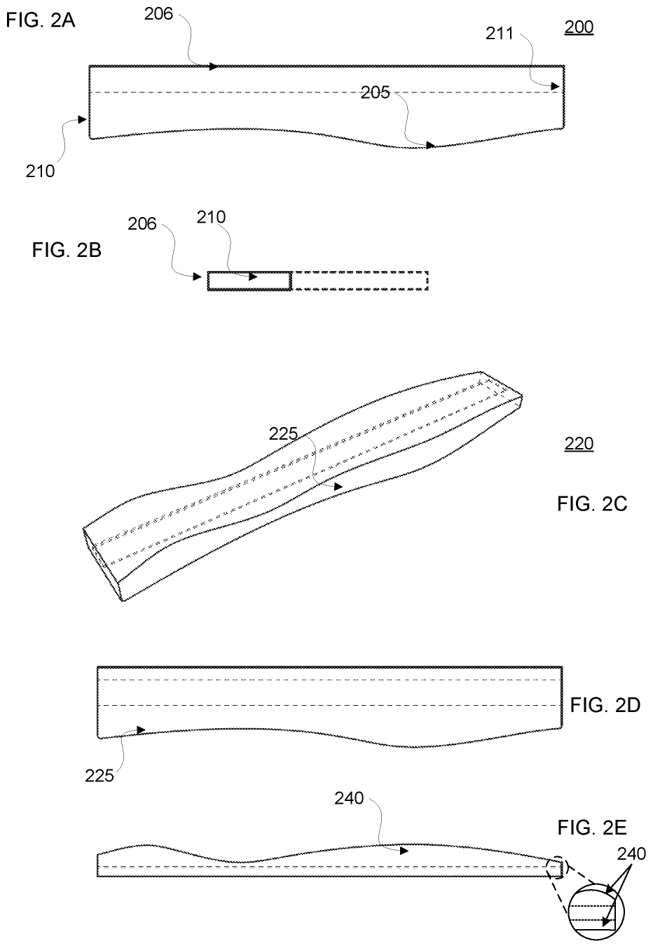

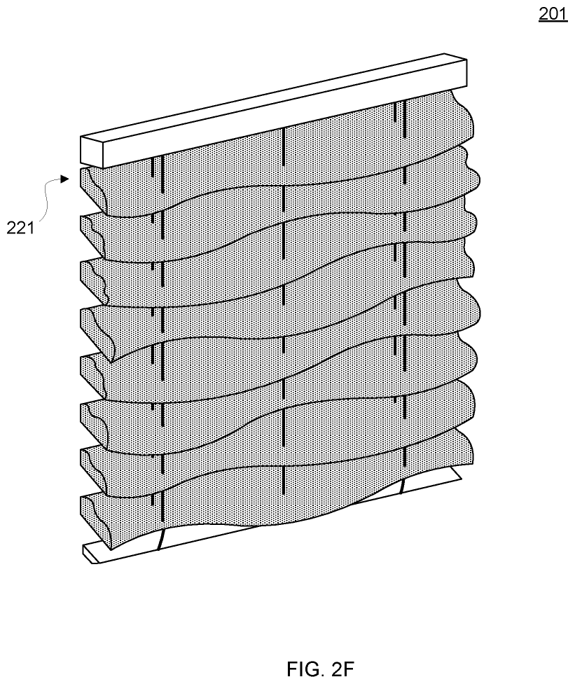

Referring now to FIG. 2A-2B, an exemplary sculptural slat 200 with a meandering profile is illustrated. In some aspects, a sculptural slat 200 may comprise a first longitudinal end 205 with a meandering profile, a second longitudinal end 206, a first latitudinal end 210, and a second latitudinal end 211. In some embodiments, each of the ends may be perpendicular to the other. In aspects, the meandering profile may comprise a curvilinear profile.

Referring now to FIG. 2C-2E, an exemplary sculptural slat 220 sculpted in two or more axes with variable thickness 240 and a first longitudinal end 225 with meandering profile is illustrated. Referring now to FIG. 2F, a perspective view of an exemplary slattable object 201 is illustrated comprising a plurality of sculptural slats 221 with variable thickness. When activated, manually or automatically with a remote controller or other non-limiting external device, the plurality of integration mechanisms 220 move the plurality of sculptural slats 210 along at least two two-dimensional axes. The design, shape, thickness, height, width, texture, and appearance of the plurality of sculptural slats 210 may vary randomly, though this is a non-limiting example. When in the closed position, the plurality of sculptural slats 210 may overlap in a non-complimentary iteration to completely cover, seal, or block the interior environment from the impact of ambient variables.

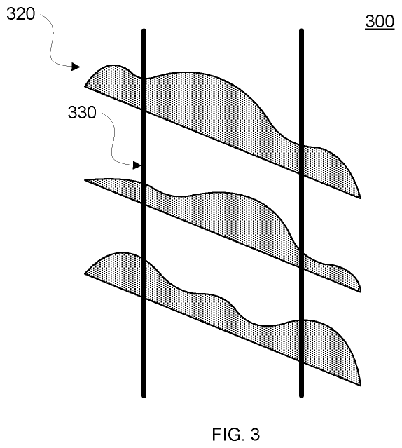

Referring now to FIG. 3, a side view of exemplary sculptural slats 300 is illustrated, wherein the sculptural slat series 300 comprises a plurality of sculptural slats 320 having variable thicknesses. In some aspects, the sculptural slat series 300 may be connected by a sculptural slat framework integration mechanism 330. In some aspects, the sculptural slat series (not shown) may comprise a plurality of sculptural slats 320 having a single, uniform thickness.

In some implementations, the sculptural slat series 300 may comprise a plurality of sculptural slats 320 that comprise a variable thickness across the series. In some aspects, the sculptural slat series 300 may comprise a variable plurality of sculptural slats 320, wherein each sculptural slat is of a single variable thickness or of multiple thicknesses, wherein portions of a sculptural slat are wider than others.

In some embodiments, the integration mechanism 330 may move the sculptural slats 320 through a plurality of transitory positions from a first, closed position to a second, open position. The integration mechanism 330 may operate when manually or automatically activated.

In some aspects, the integration mechanism 330 may move the sculptural slats 320 on a two-dimensional plane. In some implementations, the integration mechanism 330 may move the sculptural slats on an additional dimensional plane, allowing for customization of the sculptural slat series, whether for ornamental or functional reasons.

For example, the sculptural slats 320 may comprise one or more meandering profiles, one or more of which may be straight, curved, scalloped, jagged, or any other non-limiting geometric example. In some embodiments, the plurality of meandering profiles may vary among the sculptural slats 320. In some implementations, the meandering profiles may form one or more latitudinal and longitudinal ends.

When the sculptural slats 320 are in the first, closed position before manual or automatic activation of the integration mechanism 330, the plurality of edges of the sculptural slats 320 may align so that the sculptural slat series 300 creates an impenetrable ambient variable barrier. In other words, no light, sound, air, or other non-limiting ambient variable may travel through the sculptural slats 320 in the first, closed position.

In some aspects, the plurality of latitudinal ends of the sculptural slats 320 may misalign in the first, closed position so that the sculptural slat series 300 creates a partially-impenetrable ambient variable barrier. In other words, light, sound, air, or other non-limiting ambient variable may travel through a portion or several portions of the arrangement in the first, closed position.

When activated, the integration mechanism 330 may move the sculptural slats 320 about a two-dimensional plane, from a first, closed position to a second, open position. In some embodiments, there may be a third, closed position opposite the first, closed position, wherein the arrangement of the sculptural slats 320 is diametrically opposed between the first and third positions. The movement between the first and second positions, and in some instances the third position, may occur along a cartesian or transverse plane, or another two-dimensional plane, such as a diagonal plane. The movement may occur isometrically, laterally, rotationally, or in another non-limiting way.

In some aspects, additional movement may occur along an additional dimensional plane. This additional movement may mirror, match, oppose, or diverge the movement between the first, second, and potentially third positions. For example, in addition to a horizontal, vertical, diagonal, or other non-limiting movement between the first, second, and potentially third positions along a cartesian, transverse, diagonal, or other non-limiting two-dimensional plane, the sculptural slats 320 may move isometrically, laterally, or rotate, or move in any non-limiting way, in any direction along a third dimensional plane. In some embodiments, the sculptural slats 320 may surge, sway, and heave in addition to moving along a two-dimensional plane, though these are non-limiting examples.

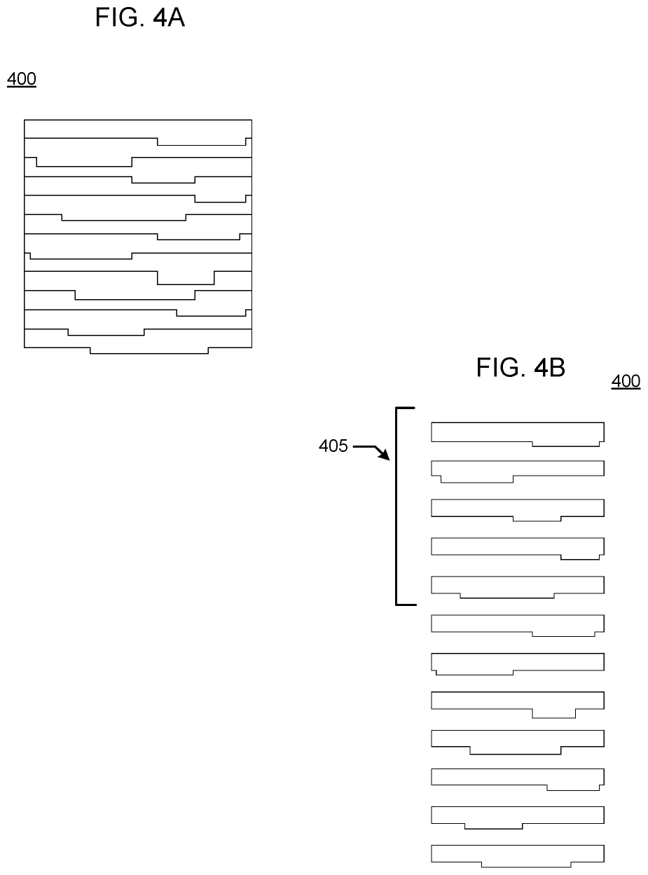

Referring now to FIGS. 4A and 4B, an exemplary series of variable sculptural slat designs 400 is illustrated, wherein the sculptural slat designs have substantially different orthogonal, non-rectilinear profiles along their longitudinal ends. FIG. 4A illustrates a closed grouping of the variable sculptural slat designs 400 from one exemplary orientation. FIG. 4B illustrates a separate grouping of the variable sculptural slat designs 400 to illustrate individual sculptural slats, wherein a pattern set 405 of sculptural slats may be repeated. These sculptural slat shapes may repeat throughout a series, or they may vary throughout. These sculptural slat shapes may alter the appearance of the sculptural slat structure, or have different decorative characteristics, depending on its orientation. There is a potential for an extensive range of orientations and decorative characteristics utilizing permutations of degrees for perspective and a sculptural slat structure designs.

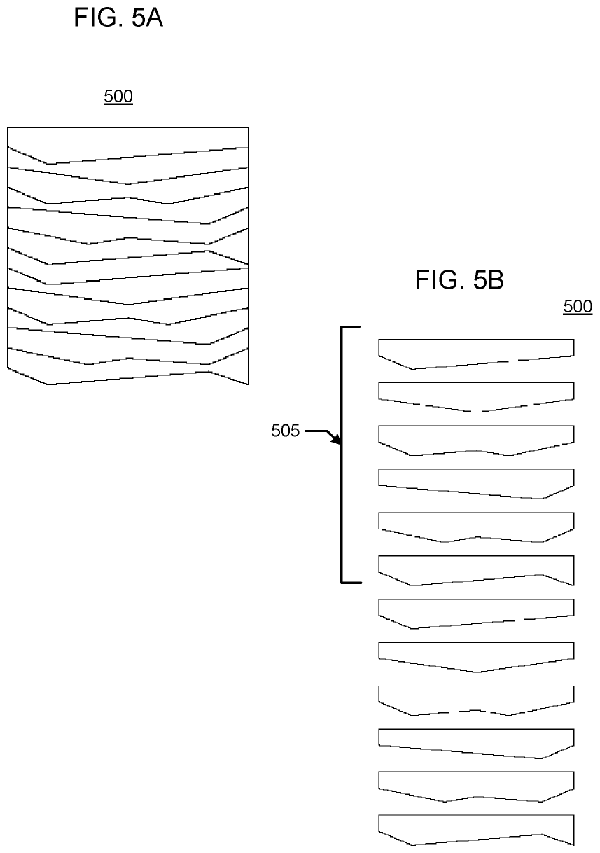

Referring now to FIGS. 5A and 5B, an exemplary series of variable sculptural slat designs 500 is illustrated, wherein the sculptural slat designs have substantially different angular, non-rectilinear profiles along their longitudinal edges. FIG. 5A illustrates a closed grouping of the variable sculptural slat designs 500 from one exemplary orientation. FIG. 5B illustrates a separate grouping of the variable sculptural slat designs 500 to illustrate individual sculptural slats, wherein a pattern set 505 of sculptural slats may be repeated. In some embodiments, FIGS. 5A and 5B may include a sculptural slat sub-series wherein sculptural slat shapes may repeat throughout the sculptural slat series.

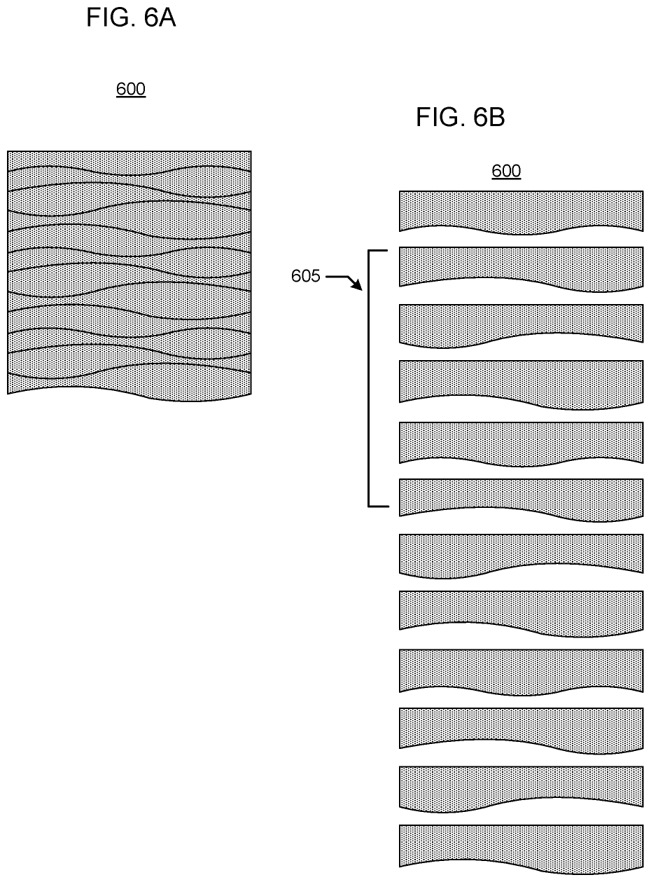

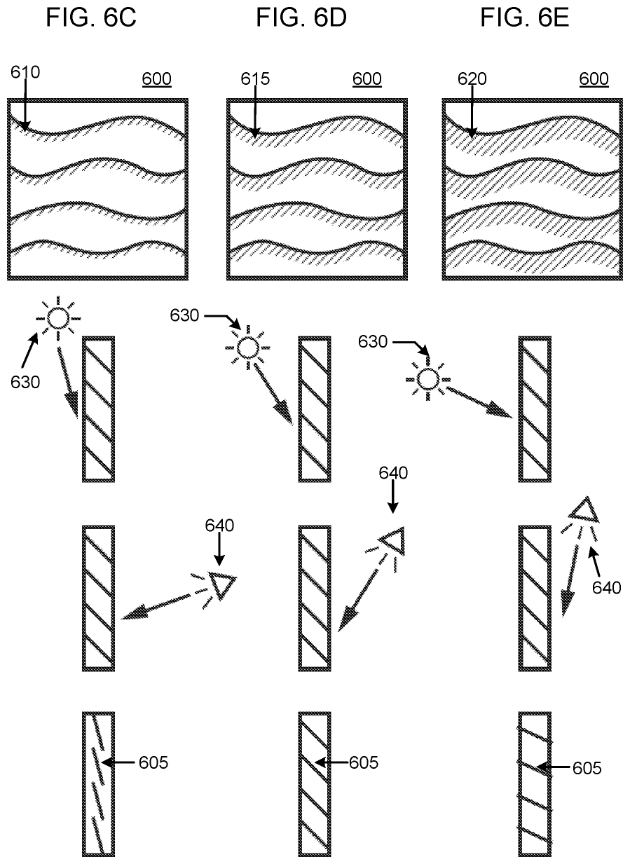

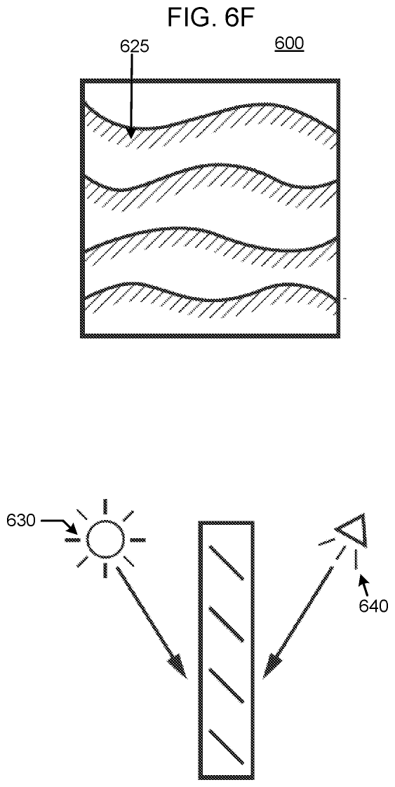

Referring now to FIGS. 6A and 6B, an exemplary series of variable sculptural slat designs 600 is illustrated, wherein the sculptural slat designs have substantially different curvilinear, non-rectilinear profiles along their longitudinal edges. FIG. 6A illustrates a closed grouping of the variable sculptural slat designs 600 from one exemplary orientation. FIG. 6B illustrates a separate grouping of the variable sculptural slat designs 600 to illustrate individual sculptural slats, which, for illustrative purposes have non-rectilinear profiles along one or both of their longitudinal edges. In some embodiments, FIGS. 6A and 6B may include a sculptural slat sub-series 605 wherein sculptural slat shapes may repeat throughout the sculptural slat series.

Referring now to FIGS. 6C-6F, an exemplary series of sculptural slats 600 with different ambient variable impact and associated conditions that may cause the ambient variable impact 610, 615, 620, 625 is illustrated. In some aspects, a series of sculptural slats 600 may be installed between an exterior and an interior, such as in front of an exterior window. In some aspects, the further away and lower down the light source is located behind the slats, the deeper the ambient variable impact appears on adjacent slats and surfaces. In some embodiments, the closer and higher up the light source is located behind the slats, the shallower the ambient variable impact appears on adjacent slats and surfaces.

In some implementations, the further away and lower down the light source is located in front of the slats, the shallower the ambient variable impact appears on adjacent slats and surfaces. In some aspects, the closer and higher up the light source is located in front of the slats, the shallower the ambient variable impact appears on adjacent slats and surfaces, and the more open the rotational orientation of the slats within the sculptural slat structure, the deeper the ambient variable impact appears on adjacent slats and surfaces. The more closed the rotational orientation of the sculptural slats within the sculptural slat structure, the shallower the ambient variable impact appears on adjacent slats and surfaces.

Referring to FIG. 6C, a shallow ambient variable impact 610 may be caused where an external light source 630 may be located high in the sky, an internal light source 640 may be located almost perpendicular to the sculptural slat structure, or where the sculptural slats 605 may be angled in a closed position. Referring to FIG. 6D, a moderate ambient variable impact 615 may be caused where an external light source 630 may be located at a moderate position in the sky, such as around midday or midmorning; an internal light source 640 may be located at a more moderate angle to the sculptural slat structure, or where the sculptural slats 605 may be angled in a moderate position.

Referring to FIG. 6E, a significant ambient variable impact 620 may be caused where an external light source 630 may be located low in the sky, an internal light source 640 may be located almost parallel to the sculptural slats, or where the sculptural slats 605 may be angled in an open position. Referring to FIG. 6F, a moderate ambient variable impact 625 may be caused where both an external light source 630 and an internal light source 640 may be located at similar positions relative to the sculptural slats.

In some embodiments, there can be different light sources either in front of or behind the sculptural slats which generate different ambient variable impacts on the sculptural slat structures simultaneously. For example, a blue colored light source at dusk from a first environment may be absorbed by the areas of the sculptural slats closest to the first environment. A yellow colored light source from electric light inside may be absorbed by the areas of the sculptural slats closest to the second environment. Shadows will be cast differently on areas of the sculptural slats depending on the position and angle of the light sources in the first and second environments. In some aspects, the ambient variable impact may also include, as non-limiting examples, sound; temperature control.

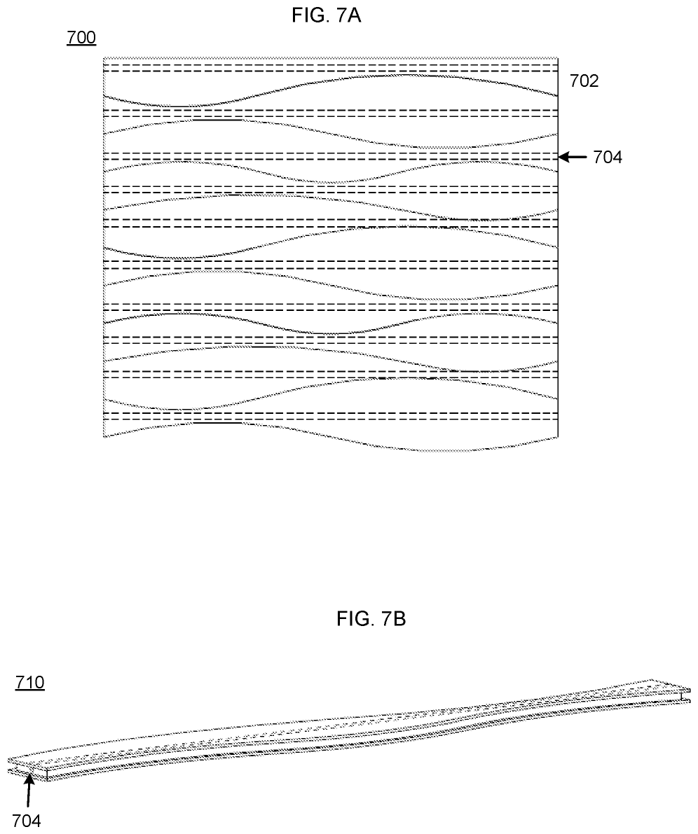

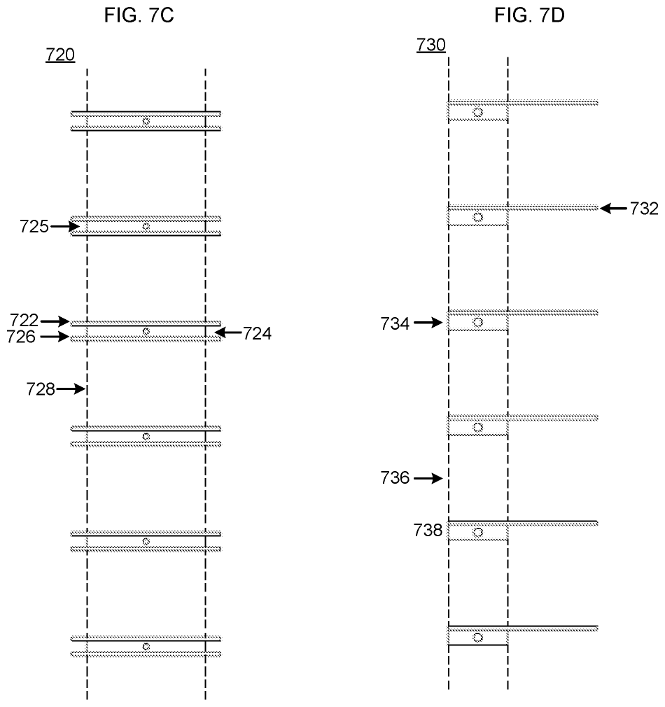

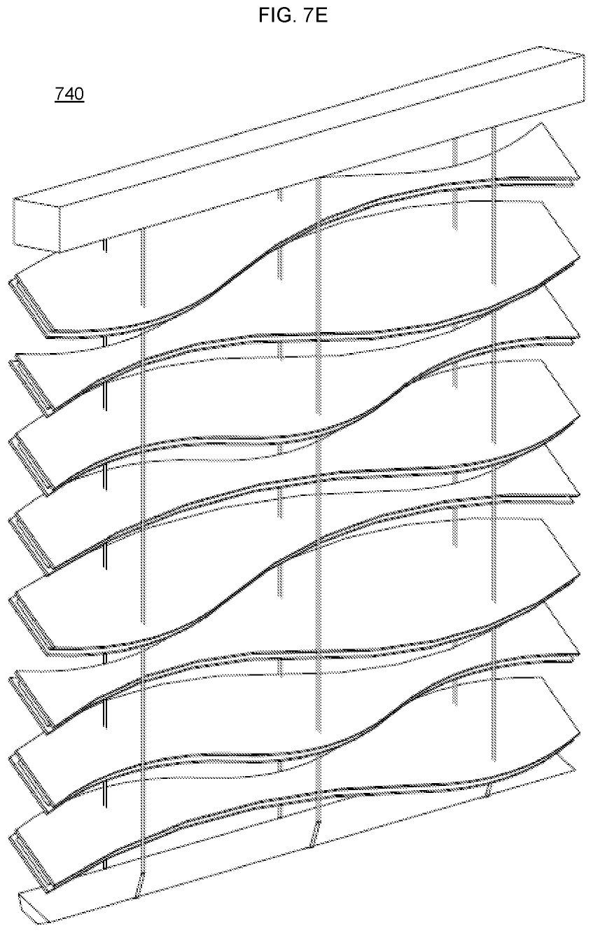

Referring now to FIGS. 7A and 7B, an exemplary series of variable sculptural slat designs 700 is illustrated, wherein a sculptural slat 702 may have a light source inside a sculptural slat, slattable object, or sculptural slat structure that creates an illuminated sculptural feature. FIG. 7A illustrates an exemplary sculptural slat structure of variable sculptural slat designs 700 with backlighting from one exemplary orientation. FIG. 7B illustrates an exemplary isometric view of a sculptural slat 710 incorporating a light-source 704.

The sculptural slat 702 may be connected to or incorporate a light source 704 that may connect to another sculptural slat, creating a chain of sculptural slats 702 and light sources 704 to create the illuminating display or functionality. In some aspects, the sculptural slat 702 itself may comprise the light source 704. In some implementations, a light source 704 may provide backlighting to the sculptural slat 702 or the closed grouping of variable sculptural slat designs within a sculptural slat structure 700. A light-source 704 may be attached to a power source, which may be internal, such as a battery or solar powered, or external, such as through a cable or plug.

In some embodiments, the sculptural slats 702 may be coated with phosphorescent material to be able to radiate visible light after being energized, either by natural or artificial light. This may be coupled with a light source 704 to either increase or vary the intensity of light emitted from the sculptural slat. A variety of phosphorescent elements may be used to create “glowing” functionality, which may depend on the persistence and/or color of light sought. For example, a sculptural slat 702 may be coated with strontium aluminate or zinc sulfide to provide longer bursts of illumination when there is no lighting. In some aspects, the phosphor may be mixed into a sculptural slat 702 and molded within it.

In some implementations, a user may be able to control the lighting functionality through various control inputs, such as through a smart device, wall mounted controls, on the sculptural slat structures themselves, or by some other means. In some embodiments, light sources 704 may be interchangeable, transitional, programmable, or extractable to provide a variety of different lighting options. In some aspects, where a light source 704 may be embedded in the sculptural slat structure 700 itself, or the sculptural slat structure 700 hosts the light source 704, the sculptural slat 702 may be customized or removable to create custom designs and/or light patterns.

Light sources 704 may include a variety of luminescent materials, including, but not limited to, light-emitting diodes, fluorescents, organic light-emitting diodes, polymer light-emitting diodes, active-matrix organic light-emitting diode, phosphorescent materials, and ultraviolet materials. Liquid crystals may be used to filter or control one or both color and light sources. Materials listed may be combined to create different coloring, luminescent, or display effects.

As an illustrative example, the sculptural slat 702 may be coated in liquid crystal, and the light source 704 may comprise light-emitting diodes, wherein the light-emitting diodes may emit a range of colors. The orientation of the liquid crystal coating may be controlled separately to adjust the perceived brightness of the light-emitting diode.

Referring now to FIGS. 7C and 7D, side views of exemplary sculptural slats are illustrated indicating exemplary configurations as to how sculptural slats with a light-source may connect to one another, such as being placed between two sculptural slat layers 720 or being connected to an individual sculptural slat layer 730. This chain then continues throughout the series of sculptural slats demonstrated in FIG. 7A. FIG. 7C illustrates a side view of an exemplary series of sculptural slats 720 wherein a sculptural slat 722 connects to a light source 724 which then connects to another sculptural slat 726, comprising a dual sculptural slat and light source unit 725, which then connects to another set by some integration mechanism 728. In some embodiments, the asymmetric pattern may accentuate the aesthetics provided by the light source 624. FIG. 7D illustrates a side view of an exemplary series of sculptural slats 730 wherein a sculptural slat 732 connects to a light source 734, comprising a sculptural slat and light source unit 738, which then connects to another set by some integration mechanism 736. The integration mechanism may comprise a string ladder, stacked sculptural slats, or other methods of connecting a series of sculptural slats 720. In some aspects, the integration mechanism may connect a primary power source to the light sources within the series of sculptural slats.

Referring now to FIG. 7E, an exemplary sculptural slat structure containing a series of sculptural slats wherein a sculptural slat may have a light source that creates a glowing feature or provides an illuminated sculptural slat is illustrated. In some aspects, the illumination of the sculptural slats may be independently controlled. As an illustrative example, the illumination of two of the sculptural slats may be off, four of the sculptural slats may be illuminated in a static color, and for the remaining two, the illumination may cycle through a range of colors.

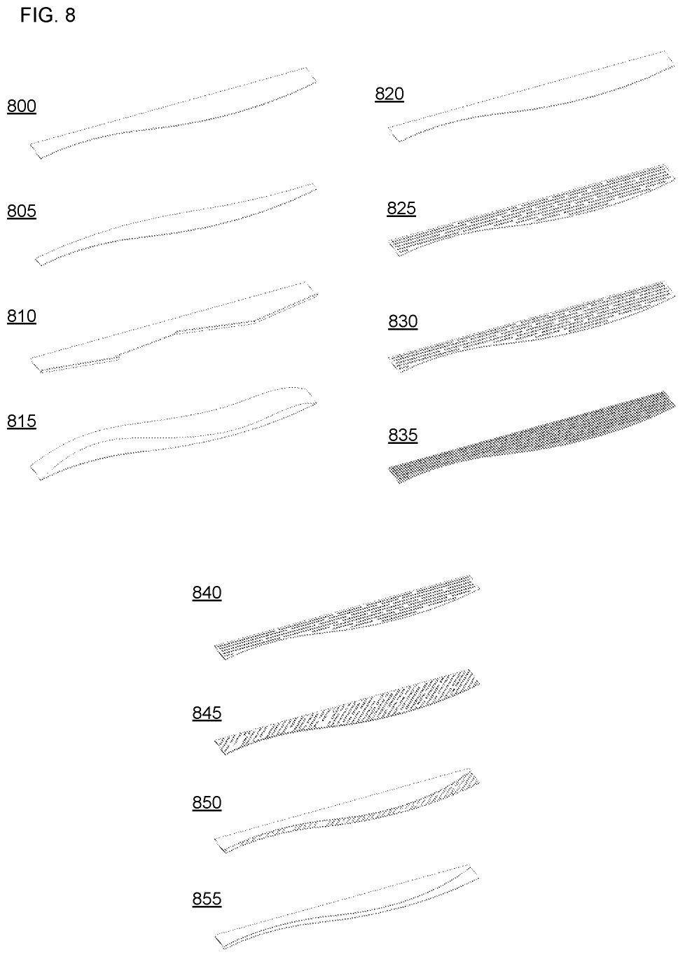

Referring now to FIG. 8, an exemplary series of variable sculptural slat designs is illustrated, including a slat with one longitudinal end with a meandering profile 800, a slat with two longitudinal ends with a meandering profile 805, a slat with bent edges 810, a slat with variable thickness 815 by additive or subtractive manufacturing methods, a solid color slat with no pattern 820, a slat with a cut pattern 825, a slat with a scored pattern 830, a slat with color contrast with a scored pattern 835, a single layer slat with a cut pattern 840, a multiple layered slat with cut patterns combined to create a new blended pattern 845, a combined solid sculptural layer with a cut pattern 850, a slat with combined multiple layers of solid sculptural slats 855.

In some aspects, these sculptural slat variations may be mixed and matched to create different sculptural slat designs, wherein the base sculptural slat element was the same. In some embodiments, different sculptural slat designs may facilitate different ambient variable impact, such as controlling how much light comes through or how light appears through each sculptural slat. For example, one sculptural slat design may represent a three-dimensional sculptural slat for decorative characteristics while another sculptural slat design 830 may control how much light comes through. For ambient variable impact, these design variations may be combined to control a variety of functional and decorative characteristics in the sculptural slats.

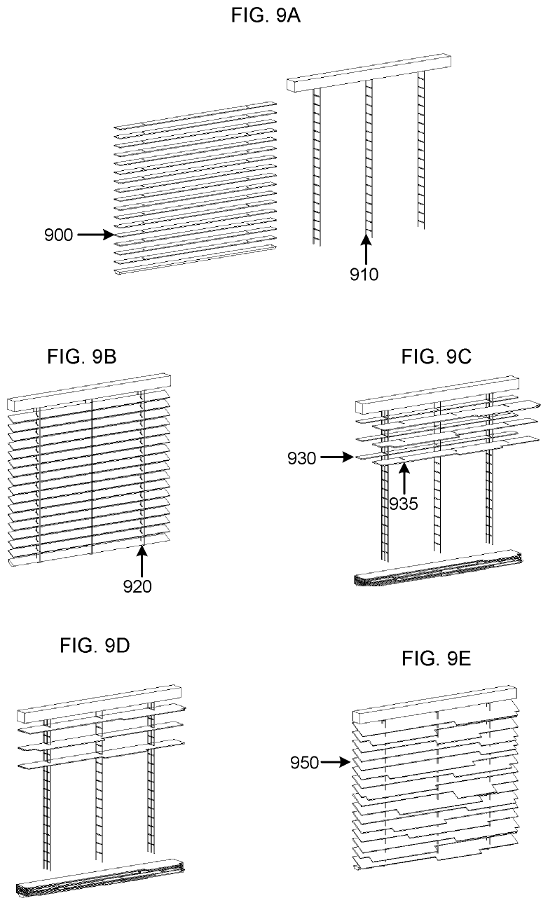

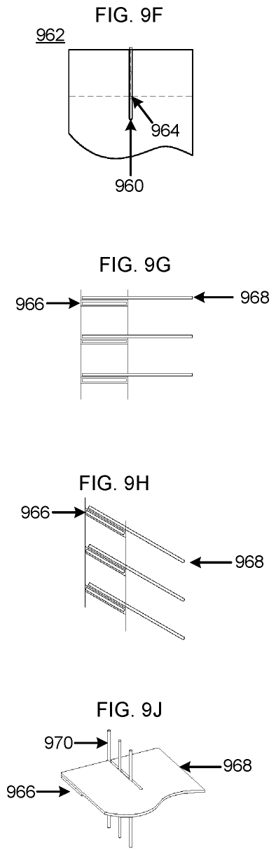

Referring now to FIGS. 9A-9E, exemplary method steps of assembling multi-layered distinctive sculptural slat composites using conventional blinds and an integration mechanism is illustrated. FIG. 9A illustrates a bottom layer of a sculptural slat composite 900 being prepared to slide horizontally along the length of a sculptural slat through a string ladder rung 910. FIG. 9B illustrates how pull cords of a string ladder 920 may be slid vertically through slattable object integration feature in the bottom layer of a sculptural slat composite 900. FIG. 9C illustrates a top layer of a sculptural slat composite 930 whose corresponding slattable object integration feature 935 can align with a corresponding string ladder 920 so that the integration mechanism may be inserted into the slattable object integration features they align with. FIG. 9D illustrates a top layer of a sculptural slat composite 930 that may be aligned directly above a bottom layer of a sculptural slat composite 900 so that the two layers may be attached together with a string ladder 920 rung between the bottom layer of a sculptural slat composite 900 and top layer of a sculptural slat composite 930. FIG. 9E illustrates a series of sculptural slats 950 that may rotate in unison with a string ladder rung 910 through various transitional states, ranging between open-to-view and closed-to-view positions.

In some implementations, there may be variations on sculptural slat articulation, which may include variations on score pattern, cut pattern, color pattern, layer shapes, layer patterns, contour, bend, and sculpted thickness, as non-limiting characteristics. These variations may form an asymmetrical pattern when the sculptural slats are placed on a conventional set of blinds. For example, the sculptural slats may comprise a plurality of rounded contours designed to imitate the shape of underwater air bubbles. When viewing a series of sculptural slats, the series of sculptural slats may comprise an asymmetrical pattern that may provoke a feeling of being underwater that may not be visibly intuitive when viewing two or more sculptural slats separately.

In some aspects, variations may depend on color, materials, or orientation. In some embodiments, the positioning of slattable object integration features may depend on the functionality of the sculptural slats, which may include a variety of uses, such as, but not limited to, blinds, shutters, louvers, vertical blinds, wall panels, ceiling clouds, vents, screens, furniture, baskets, drawers, doors, gates, pergolas, trellises, or fences.

Referring now to FIGS. 9F-9J, a multi-layered sculptural slat joint 960 within a sculptural slat composite 962 may envelop an integration mechanism 964 between a bottom layer 966 and a top layer 968 and sit within an integration mechanism 980. In some implementations, a bottom layer 966 of a sculptural slat composite may be inserted horizontally through the clear opening dimensions of the integration mechanism 964 so that the multiple strings of a rung may loop around the bottom layer. In some aspects, a bottom layer 966 of a sculptural slat composite may rest on top of each string ladder rung 964.

In some implementations, a multi-layered sculptural slat joint 960 may comprise a slattable object integration feature to align with each integration mechanism so that an integration mechanism may be inserted into the top layer 968 in a direction perpendicular to the sculptural slat's length. In some aspects, once a top layer 968 is directly above the bottom layer 966, the two layers may be attached to one another with an integration mechanism 964 fitting in between.

In some embodiments, when the bottom layer 966 and a top layer 968 are attached together, a sculptural slat composite 962 may rotate in unison with or without an integration mechanism 980 between various transitional states, ranging from open-to-view to closed-to-view positioning. In some aspects, the slattable object integration feature may extend through the slat slicing the sculptural slat into segments that connect together in a multi-layered slattable object integration feature. This slattable object integration feature connects to the integration mechanism to attach or rotate the sculptural slat within a sculptural slat structure.

In some implementations, a middle layer may be used to stabilize a string ladder or to provide further support to either the bottom or top layer. In some aspects, a middle layer may be inserted horizontally into an integration mechanism with a bottom layer to then attach to an integration mechanism together. In some embodiments, a top layer may then attach to the bottom and middle layer once it is directly above the bottom and middle layers and aligns with each integration mechanism so that each integration mechanism may be inserted into the top layer in a direction perpendicular to a sculptural slat's length. In some implementations, a bottom, middle, and top sculptural slat layer may attach together, wherein this sculptural slat composite may rotate in unison with or without a: integration mechanism between various transitional states, ranging from open-to-view to closed-to-view positioning while resisting the overturning forces exerted on the top layer.

In some embodiments, a joint may attach a: integration mechanism to a sculptural slat creates structural support for the depth of the sculptural slat that cantilevers beyond the vertical supports of the integration mechanism, with the depth being larger than all the clear open dimensions of a string ladder. In some aspects, when the sculptural slat is supported by the integration mechanism rung below, it may create a joint that allows a blinds assembly to move in unison, which resists overturning forces as the sculptural slat properly rotates between various states of transition, from open-to-view to closed-to-view positions.

In some implementations, a joint may comprise a slot cut in a sculptural slat through which an integration mechanism may be inserted. In some aspects, once aligned with a corresponding rung of a string ladder, a sculptural slat may be shifted to one side so that multiple strings of an integration mechanism may loop around a sculptural slat with at least one string on top and at least one string on the bottom of a sculptural slat. In some aspects, a loop binds a sculptural slat to the integration mechanism so that it may counteract the overturning forces exerted on a sculptural slat as it rotates between various transitional states, including, but not limited to, open-to-view to closed-to-view positions.

In some embodiments, a bottom layer may host a joint that is comprised of a slot through which an integration mechanism may be inserted. In some aspects, a sculptural slat may be shifted to one side that multiple strings of an integration mechanism may loop around a multi-layered joint with at least one string on top and at least on a string on the bottom of the layer once aligned with a corresponding rung of an integration mechanism. In some implementations, a top layer of this sculptural slat composite has a slot aligning with each integration mechanism so that an integration mechanism may be inserted into a top layer in a direction perpendicular to a sculptural slat's length.

In some aspects, once a top layer is directly above a bottom layer, the two layers may be attached together with an integration mechanism between them. In some embodiments, when sculptural slat layers are attached together, a sculptural slat composite may rotate in unison with an integration mechanism between various transitional states, from open-to-view to closed-to-view positions, while resisting overturning forces exerted on the top layer.

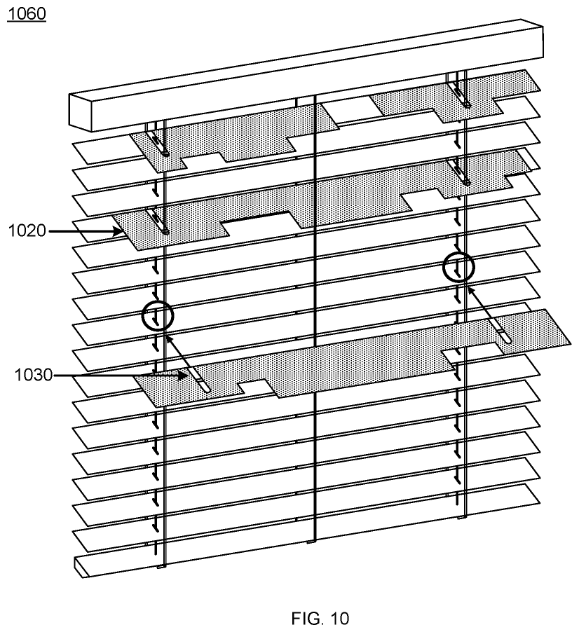

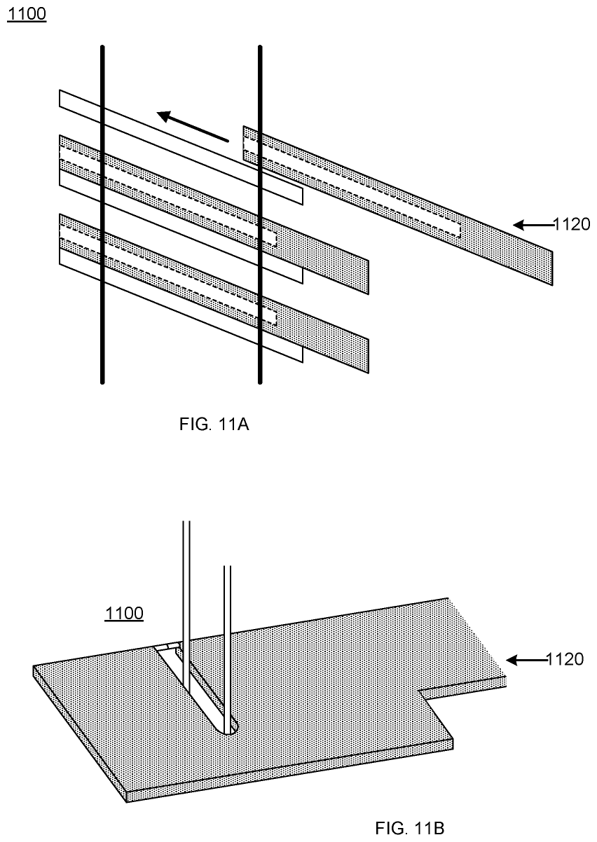

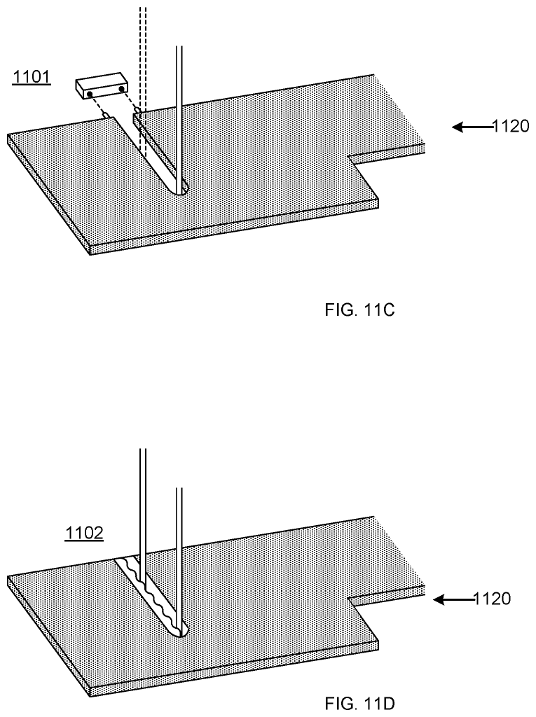

Referring now to FIG. 10, a perspective view of an exemplary slattable object 1060 is illustrated, including a removable sculptural panel structure, further comprising a plurality of sculptural slats 1020 and a plurality of integration mechanisms 1030. In some embodiments, the plurality of sculptural slats 1020 may be removable from the slattable object 1060, which may comprise a plurality of slats. In some implementations, the integration mechanisms 1030 may allow for the integration of the plurality of sculptural slats 1020 to the plurality of slats on the slattable object 1060.

In some implementations, there may be a 1:1 ratio of the plurality of sculptural slats 1020 to the plurality of slats, though this ratio is non-limiting. In some aspects, one or more sculptural slat may interface with a single slat. When integrated, the plurality of sculptural slats 1020 and the plurality of slats may have a congruent first, closed position and a second, open position while the ends of the sculptural slats 1020 may comprise an incongruent and asymmetrical pattern.

When integrated, the plurality of sculptural slats 1020 may move along a two-dimensional plane with the plurality of slats. When integrated, the plurality of sculptural slats 1020 may move along an additional dimensional plane, distinct from the two-dimensional movement of the plurality of slats, wherein the additional dimensional movement enhances the impact of the plurality of sculptural slats 1020 on local internal and external ambient variables.

For example, a homeowner may have a window located on a particular wall in their home. This wall, with the window, may face the west, either partially or wholly. The window may also comprise a window covering, such as blinds, that may include a plurality of slats. As the day progresses, and particularly around sunset, there may be an increase of light, heat, and other associated non-limiting environs, causing the interior of the home, particularly the portion closest to the window, to become overheated.

An exemplary plurality of sculptural slats 1020, when coupled to the plurality of slats through a plurality of integration mechanisms 1030, may move together along a vertical two-dimensional axis to open and close, blocking most of the light from entering. However, movement along this two-dimensional axis alone may not be enough to completely shield the interior of the home from the associated ambient variables.

In some aspects, the plurality of sculptural slats 1020 may move along a horizontal plane, from front to back or side to side, or even adjust diagonally, so as to completely shield the interior of the home from the associated environs. The meandering profiles of the plurality of sculptural slats 1020 may overlap or align in an incongruent pattern that allows for complete blockage when movement along the horizontal plane occurs.

Referring now to FIGS. 11A-D, exemplary integration mechanisms 1100, 1101, 1102 is illustrated. In some embodiments, the plurality of sculptural slats 1120 comprise a plurality of integration mechanisms 1100, 1101, 1102 that may further comprise slits by which the sculptural slats 1120 may interface with a slattable object. In some aspects, the plurality of slits may be placed on any portion of the plurality of sculptural slats 1120. In some implementations, the integration mechanisms 1100, 1101, 1102 may extend along the longitudinal or the latitudinal direction of the sculptural slats 1120.

For example, the plurality of integration mechanisms 1100, 1101, 1102 may enclose around the plurality of slats on the slattable object with a pivoting clasp, an insertable cap, a cinch tie, silicone sawtooth edge, or other non-limiting closures. In some aspects, the integration mechanisms 1100, 1101, 1102 may close around the plurality of sculptural slats 1120 so the plurality of sculptural slats 1120 may move fluidly and without obstruction.

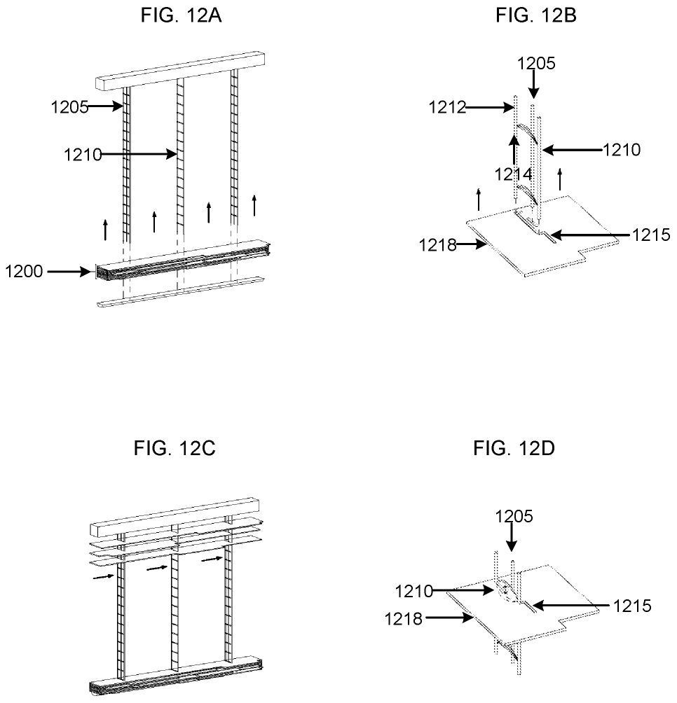

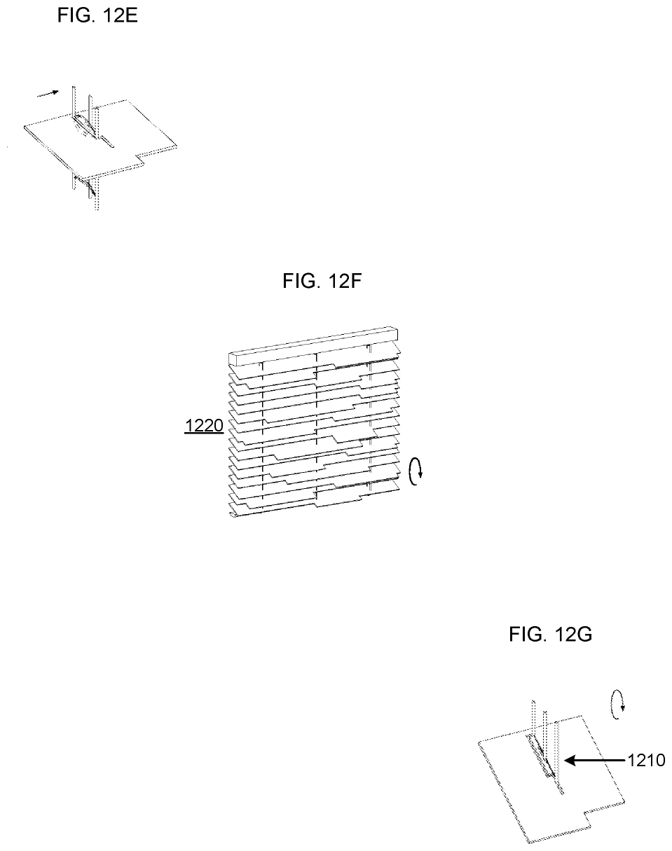

Referring now to FIGS. 12A-12G, exemplary method steps for sculptural slat structure assembly wherein a sculptural slat depth may be greater than the clear dimensions of an integration mechanism are illustrated. In some aspects, the integration mechanism may comprise a string ladder. Referring now to FIGS. 12A and 12B, exemplary method steps for sculptural slat assembly is illustrated, wherein a bundle of sculptural slats 1200, with each sculptural slat 1218 comprising a sculptural slat joint 1215, may be prepared through which an integration mechanism 1205 can be slid vertically and an integration mechanism 1210 may be slid horizontally.

Referring now to FIGS. 12C-12E, exemplary method steps for sculptural slat assembly is illustrated, wherein a bundle of sculptural slats 1200, with each sculptural slat 1218 comprising a sculptural slat joint 1215, are prepared to be slid vertically through an integration mechanism 1205 and horizontally through integration mechanism rung 1210. In some embodiments, a sculptural slat 1218 may be raised to align with a corresponding integration mechanism rung 1210. In some implementations, a horizontal rung of the integration mechanism 1205 may be spread apart to create a loop that may wrap around a sculptural slat joint 1215.

In some aspects, a vertical support 1212 and horizontal rung of the integration mechanism 1205 may be slid horizontally so that a horizontal rung of the slattable object integration mechanism integration mechanism 1205 may loop around a sculptural slat 1218 and a vertical support 1212 may move up and down freely through a slot joint 1215 when a sculptural slat 1218 is rotated. In some aspects, attaching a sculptural slat 1218 in a slot joint 1215 may structurally support the depth of a sculptural slat 1218 that may extend beyond the vertical support 1212 of a string ladder 1205.

Referring now to FIGS. 12F-12G, exemplary method steps for sculptural slat structure assembly is illustrated, wherein a series of sculptural slats 1220 may rotate in unison with integration mechanism rungs 1210. In some implementations, a series of sculptural slats 1220 may rotate in unison with a string ladder between various transitional states, from open-to-view to closed-to-view positions, while resisting overturning forces exerted on the top layer that extends beyond the structural support of the integration mechanism.

In some embodiments, a variety of counterbalances, controls, or frameworks may be used to ensure that sculptural slats 1220 may be properly used as a covering. In some aspects, this may include a version wherein a string ladder is not used. In some implementations, this may include a version where a device may be included to create uniformity amongst the multi-layered sculptural slats, such as, a bar that ensures that they rotate similarly or supports the sculptural slats within whatever framework they are placed. This uniformity may be of critical importance in ensuring uniform motion of irregular and asymmetrical groups of sculptural slats 1220.

In some aspects, this may be a weight distributed within the multi-layered sculptural slats themselves. In some embodiments, this may be a hidden bar that increases stability but is not immediately apparent to a user. In some aspects, a sculptural slat may use different forms of adhesion to stay together and continue its functionality, such as those materials listed and described in FIGS. 8A-8E.

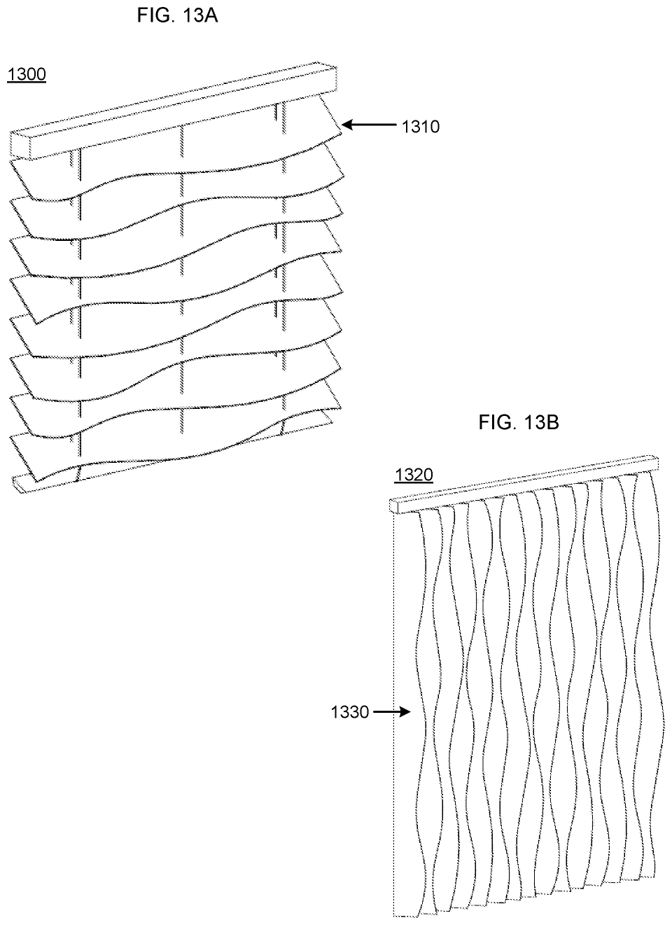

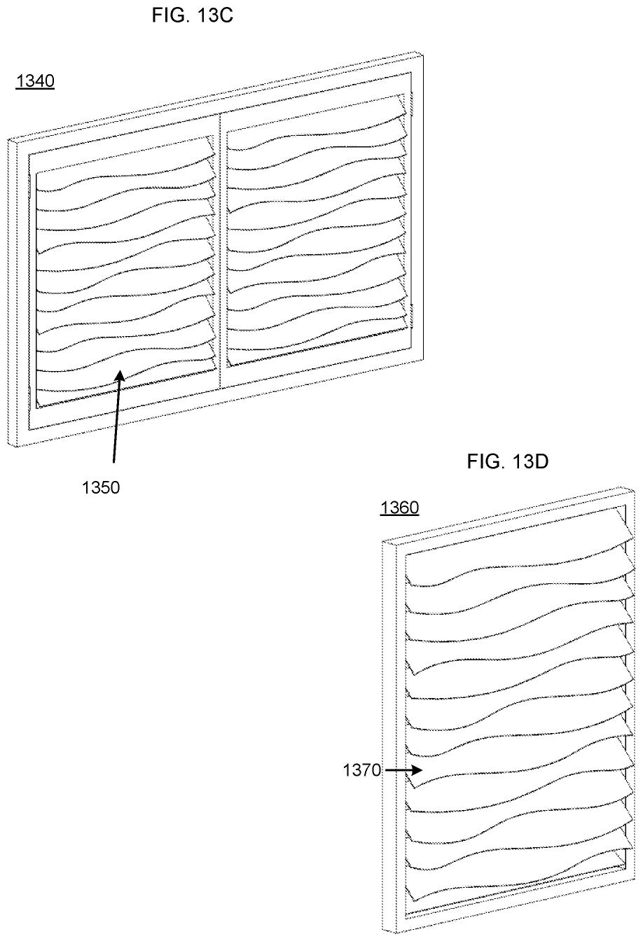

Referring now to FIGS. 13A-13D, exemplary embodiments of coverings that may use a series of sculptural slats are illustrated, wherein the series of sculptural slats have substantially different curvilinear, non-rectilinear profiles along their longitudinal ends. Referring now to FIG. 13A, an exemplary horizontal blind 1300 with a series of curvilinear sculptural slats 1310 is illustrated. Referring now to FIG. 13B, an exemplary vertical blind 1320 with a series of curvilinear sculptural slats 1330 is illustrated. In some embodiments, the curvilinear sculptural slats 1330 may comprise one or more meandering profiles along either the latitudinal or longitudinal ends, or both. Referring now to FIG. 13C, an exemplary interior shutter 1340 with a series of curvilinear sculptural slats 1350 is illustrated. Referring now to FIG. 13D, an exemplary louver 1360 with a series of curvilinear sculptural slats 1380 is illustrated.

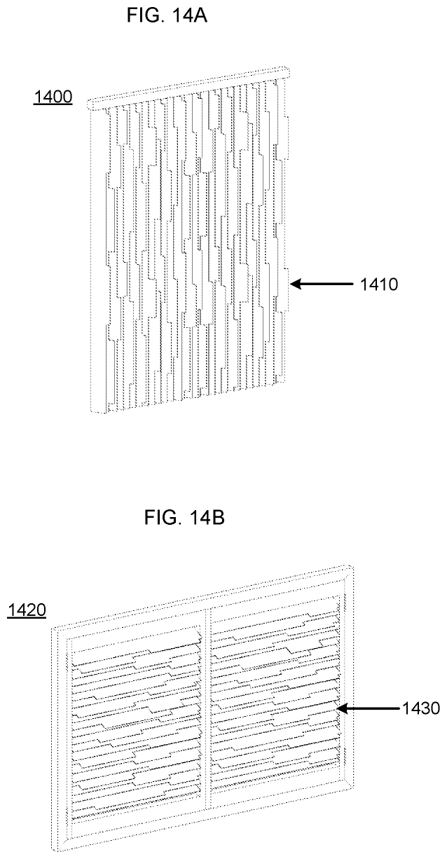

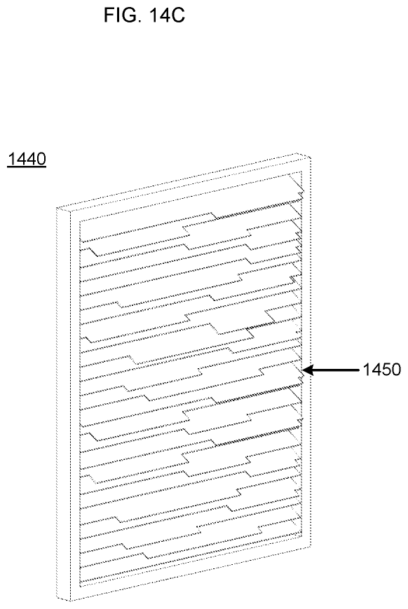

Referring now to FIGS. 14A-14C, exemplary embodiments of coverings that may use a series of sculptural slats are illustrated. Referring now to FIG. 14A, an exemplary vertical blind 1400 with a series of sculptural slats 1410 is illustrated. Referring now to FIG. 14B, an exemplary interior or exterior shutter 1420 with a series of sculptural slats 1430 is illustrated. Referring now to FIG. 14C, an exemplary louver 1440 with a series of sculptural slats 1450 is illustrated. In some embodiments, the sculptural slats 1410, 1430 may be used in applications where the facilitation of air is controlled, such as the airflow into the engine compartment of a vehicle, as a non-limiting example.

In some implementations, a series of sculptural slats may be used interchangeably within a design family. For example, a baseline sculptural slat can be pre-made or mass produced beforehand, then, these unfinished sculptural slats can be customized to fit within a variety of slatted objects or slatted structures with different sizes, colors, patterns, materials, or orientations, customized by the user. In some aspects, a series of sculptural slats may be mixed with other designs to create a new, mixed aesthetic, wherein the ambient variable impact of each sculptural slat may complement, augment, or parallel one another. For example, a sculptural slat made of certain material and design may be combined with a sculptural slat of a different material and design to affect lighting in the room. In some aspects, the sculptural slats may form an unrepetitive, asymmetrical pattern that may be unintuitive when viewing the sculptural slats separately. In some embodiments, sculptural slats may be altered or changed out depending on the functionality of the room.

For example, a room may be used for a work space during the day but may be used for entertainment or recreational purposes at night. Changing the sculptural slats may change the ambiance of the room. Similarly, if each pair of sculptural slats is paired with predefined intelligent functionality, such as home or office settings, the smart sculptural slats may respond accordingly when the ambient variables are changed. For example, when a pair of sculptural slats are used for work purposes, a predefined amount of light may be let into the room, and when the sculptural slats are changed out for recreational purposes, they may interact with the ambient environment adjusting the temperature of the room and the amount of light to let in, based on one or more received specifications, learned preferences, or typical effective and comfortable levels. Similarly, the smart slats can be paired with a “wake-up” setting synced to a user's alarm clock to let light enter a room when it is time to wake up.

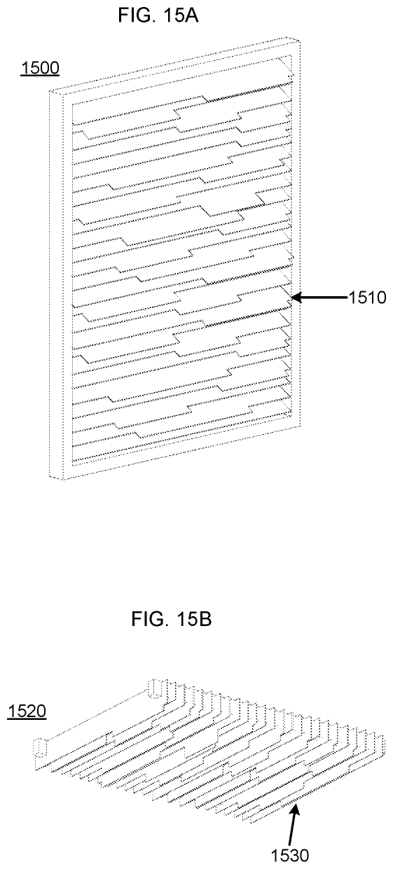

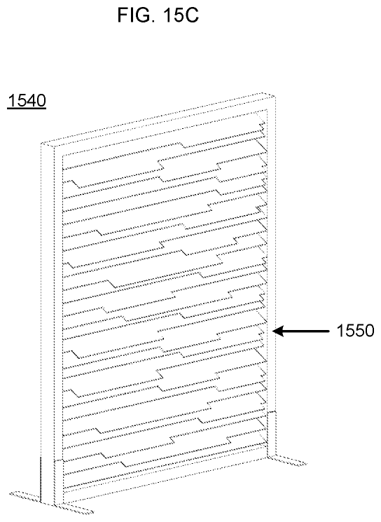

Referring now to FIGS. 15A-15C, exemplary embodiments of coverings relating to interior architecture that may integrate a series of sculptural slats are illustrated. Referring now to

FIG. 15A, an exemplary wall panel 1500 with a series of sculptural slats 1510 is illustrated. Referring now to FIG. 15B, an exemplary ceiling cloud 1520 with a series of sculptural slats 1530 is illustrated. Referring now to FIG. 15C, an exemplary privacy screen 1540 with a series of sculptural slats 1550 is illustrated. These embodiments may demonstrate the plurality of applications in which the sculptural slats may contribute the external environment.

In some embodiments, orientation or placement of the sculptural slats may be used to affect acoustics within a room. For example, a wall panel may create a dampening or amplifying effect to either contain or expand sound within a room. In some implementations, sculptural slats may achieve a dampening effect with a material having acoustical properties, such as felt, located behind the slats or comprising the sculptural slats themselves. In some aspects, depending on how a wall panel is configured, it may direct the flow of sound within a room. In some implementations, sculptural slats may be combined for a different functionality.

In some aspects, a sculptural slat may transition between orientations to provide different functionality, from controlling the flow of sounds within a room to the effect of sound within a room. In some embodiments, a family of coverings, such as a wall panel and a privacy screen, may interact with each other or amplify their functionality to further contribute to that aim, such as the acoustic control properties described herein. In some aspects, lighting may be integrated into a slattable object so that sculptural slights can manipulate the ambient variables of light, brightness, color, and intensity between a first environment behind the slats and a second environment in front of the slats.

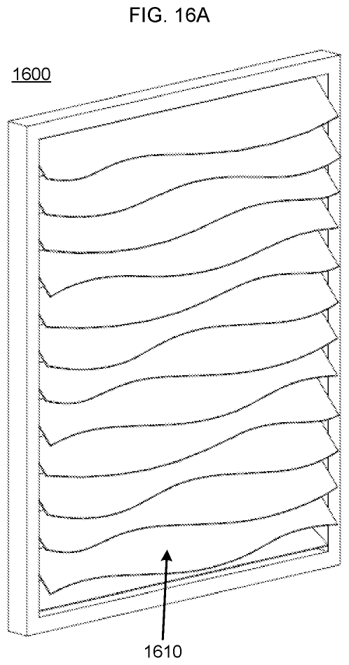

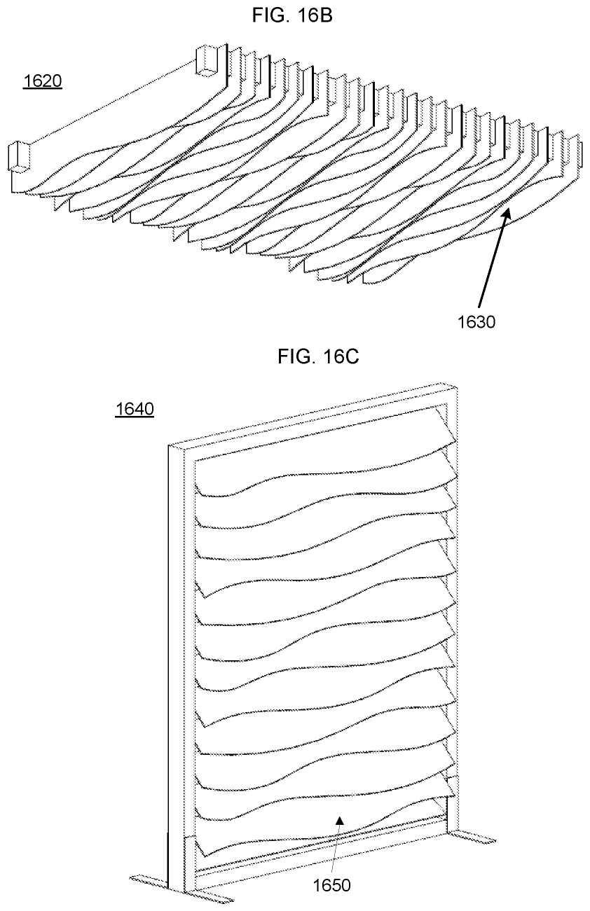

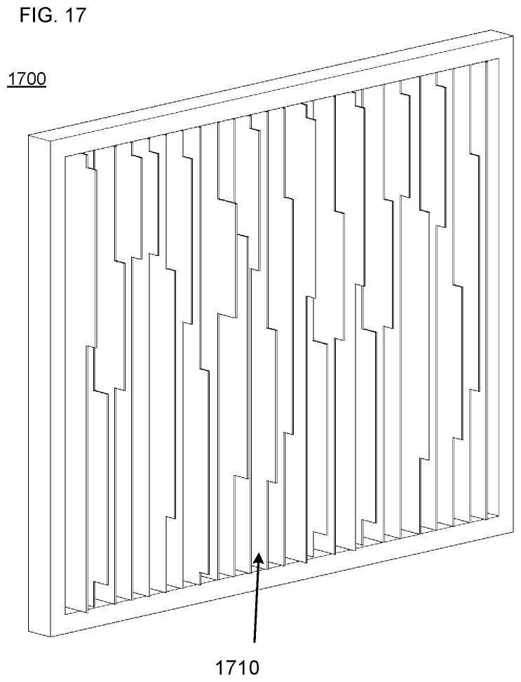

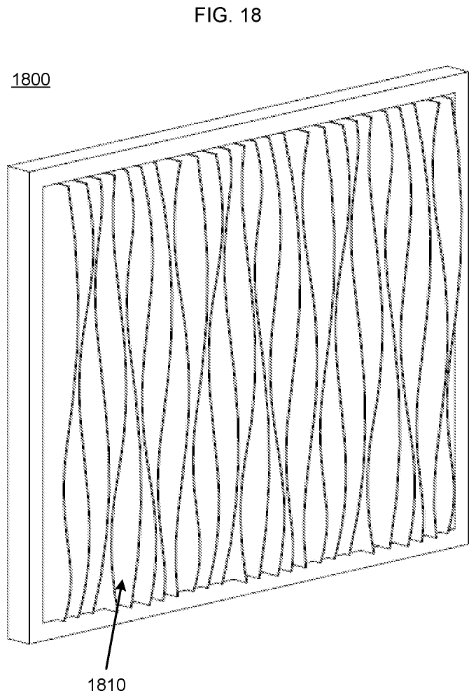

Referring now to FIGS. 16A-16C, exemplary embodiments of coverings relating to interior architecture with variable sculptural slat designs are illustrated, wherein the series of sculptural slats have substantially different curvilinear, non-rectilinear profiles along their longitudinal ends. Referring now to FIG. 16A, an exemplary wall panel 1600 with a series of curvilinear sculptural slats 1610 is illustrated. Referring now to FIG. 16B, an exemplary ceiling cloud 1620 with a series of curvilinear sculptural slats 1630 is illustrated. Referring now to FIG. 16C, an exemplary privacy screen 1650 with a series of curvilinear sculptural slats 1660 is illustrated. In some embodiments, interior architecture may have an illuminated sculptural feature integrated into the sculptural slat structures as described above in FIGS. 5A-5B.

Referring now to FIG. 17, an exemplary vent 1700 with a series of sculptural slats 1710 is illustrated. In some embodiments, FIG. 17 may illustrate a grill. In some implementations, a return and supply air conditioning vent and grill may have a series of sculptural slats. By extension, in some aspects, sculptural slats may be used for automotive uses, such as air conditioning vents or grill sculptural slats in front of a car. The transitional orientation of the sculptural slats may control the air flow, temperature, light, and shadow that pass through the slatted grill or vent in an architectural, mechanical, or automotive application.

Referring now to FIG. 18, an exemplary vent 1800 with a series of curvilinear sculptural slats 1810 is illustrated. In some embodiments, FIG. 18 may illustrate a grill or vent panel for an airflow duct. In some aspects, the vent 1800 may comprise a section of exterior cladding, such as lap siding or panel siding. In some embodiments, the incongruent nature of the meandering profiles displayed by the curvilinear sculptural slats 1810 may provide aesthetic value in addition to functional improvement.

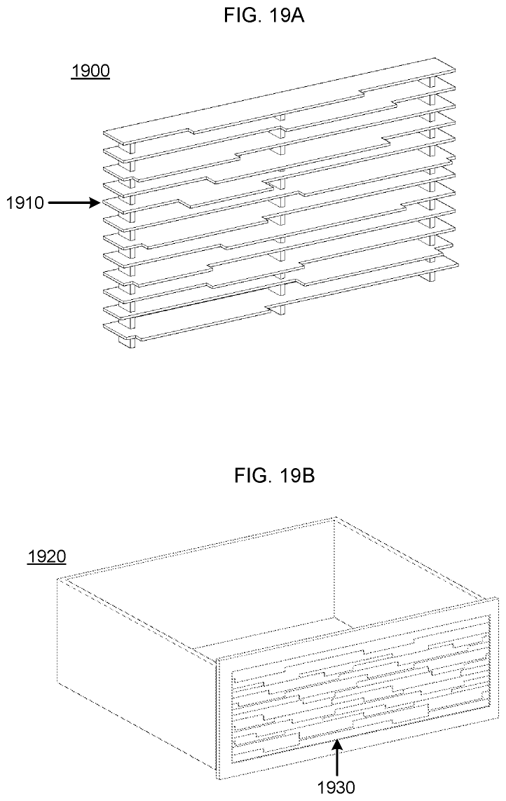

Referring now to FIGS. 19A and 19B, exemplary embodiments of interior furniture that may use a series of sculptural slats are illustrated. Referring now to FIG. 19A, an exemplary bookcase 1900 with a series of sculptural slat shelving 1910 is illustrated. Referring now to FIG. 19B, an exemplary drawer 1920 with a sculptural slat drawer front 1930 is illustrated.

In some embodiments, a sculptural slat may be used to scale privacy options. For example, a drawer with a set of sculptural slats may be manipulated so that the sculptural slats may reveal the contents of the drawer without having to slide the drawer open. This may make it more convenient should a user want to see the contents of a drawer without necessarily going through it, while ensuring that a user may reengage the privacy afforded by a covering should they not want others to see what is inside a drawer after they are done inspecting it. This functionality may also be used within the bookcase, where a sculptural slat shelf that is not being used can be manipulated to provide a covering over a shelf directly below or at some other location by fitting into the design through a variety of options, such as clicking in, sliding in, or being pushed in.

In some aspects, the sculptural slats themselves may be used to open and close the drawer, or a series of sculptural slats may be arranged in a way that the meandering profiles may resemble a handle to facilitate ease of use. In some implementations, sculptural slats may be removed or inserted should a user desire a different design or different functionality, such as removing convenience or privacy features. In the bookcase, sculptural slats may be removed or inserted per user preference to increase or decrease the size of the bookcase, including horizontally, diagonally, or vertically.

In some embodiments, alternate furniture may include baskets with sculptural slats, drawer fronts with louvered front, louver doors, sculptural slat benches, sculptural slat tables, sculptural slat tables with glass tops, crib sculptural slats, bassinet sculptural slats, floating shelves, and display cases with sculptural slats control light emission within the case, as a non-limiting list.

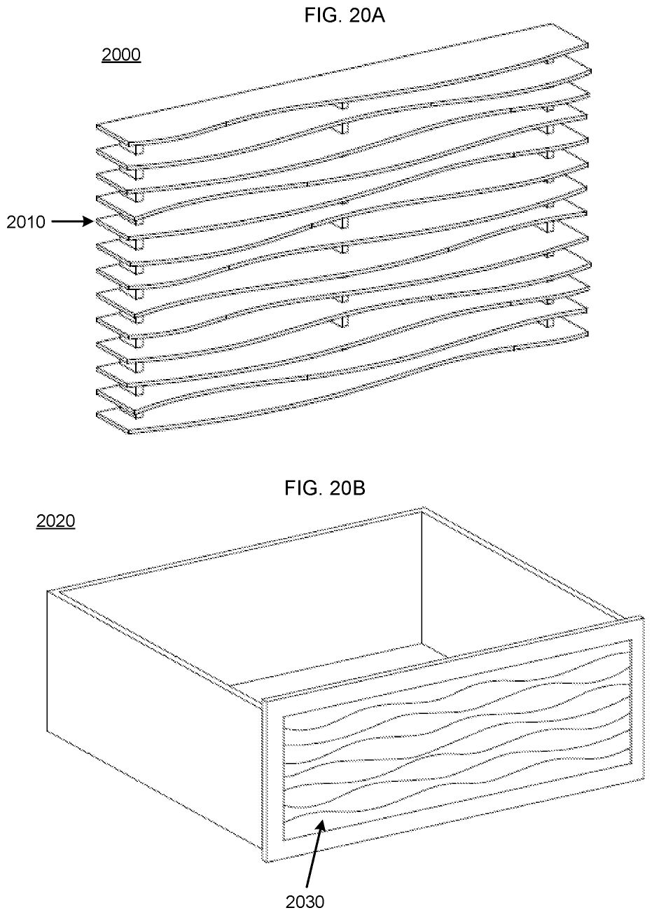

Referring now to FIGS. 20A-20B, exemplary embodiments of interior furniture that may use a series of sculptural slats are illustrated, wherein the series of sculptural slats have substantially different curvilinear, meandering profiles along their longitudinal ends, latitudinal ends, or both. Referring now to FIGS. 20A, an exemplary bookcase 2000 with a series of curvilinear sculptural slat shelving 2010 is illustrated. Referring now to FIG. 20B, an exemplary drawer 2020 with a curvilinear sculptural slat drawer front 2030 is illustrated.

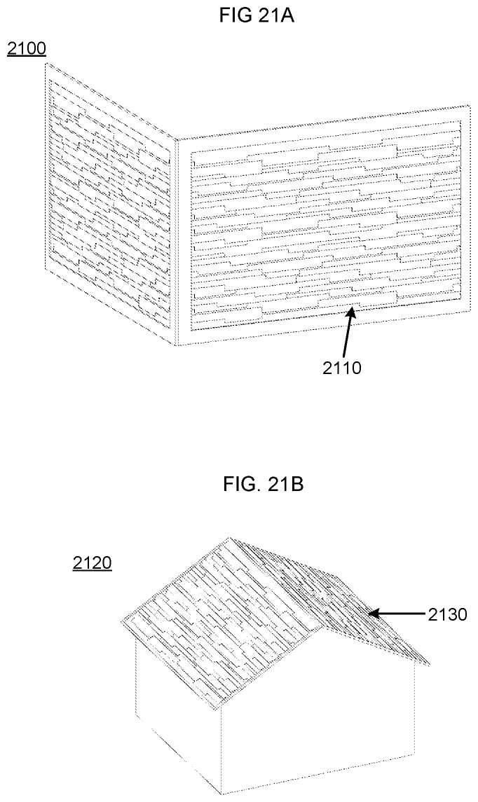

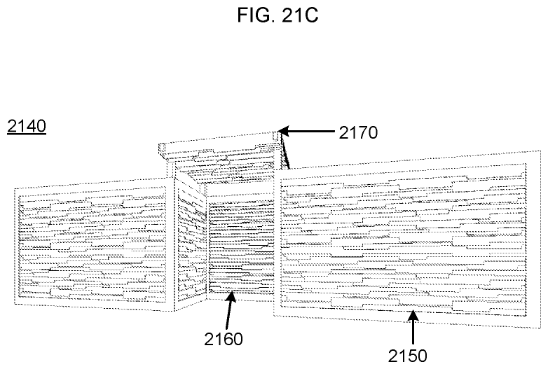

Referring now to FIGS. 21A-21C, exemplary embodiments of exterior architectural coverings that may use a series of sculptural slats are illustrated. Referring now to FIG. 21A, an exemplary lap siding 2100 with a series of sculptural slats 2110 is illustrated. Referring now to FIG. 21B, an exemplary set of roof shingles 2120 with a series of sculptural slats 2130 is illustrated. Referring now to FIG. 21C, an exemplary exterior installation sculptural slat structure 2140 is illustrated. In some embodiments, the exterior installation sculptural slat structure 2140 may comprise a fence 2150, a pergola 2180, and a gate 2160, as a non-limiting list. In some aspects, outdoor structures may include trellises, arbors, planter boxes, or raised garden boxes, as a non-limiting list.

In some implementations, a sculptural slat may be coupled with other technology for ease of use. For example, a roof shingle may include sculptural slats with transitional functionality to expose solar paneling or may incorporate solar paneling within the sculptural slats themselves, that may tilt or shift orientation to better absorb sunlight as it changes throughout the day. In some aspects, this may be done manually, through some means of user input, such as by some form of manipulation, control, or smart device, by pre-programmed means, or by adaptive technology that learns over time when to transition or rotate to best absorb sunlight, as non-limiting options.

For example, the sun's hourly, daily, weekly, monthly, or annual path can be predicted and incorporated into the movement of the panels. In some implementations, a roof shingle with sculptural slats may be embedded within another covering so that insects or precipitation do not seep into a dwelling should the sculptural slats be in a rotated state. In some aspects, a roof shingle using sculptural slat technology may consist of clay tile, asphalt, plastic, fiberglass, or metal.

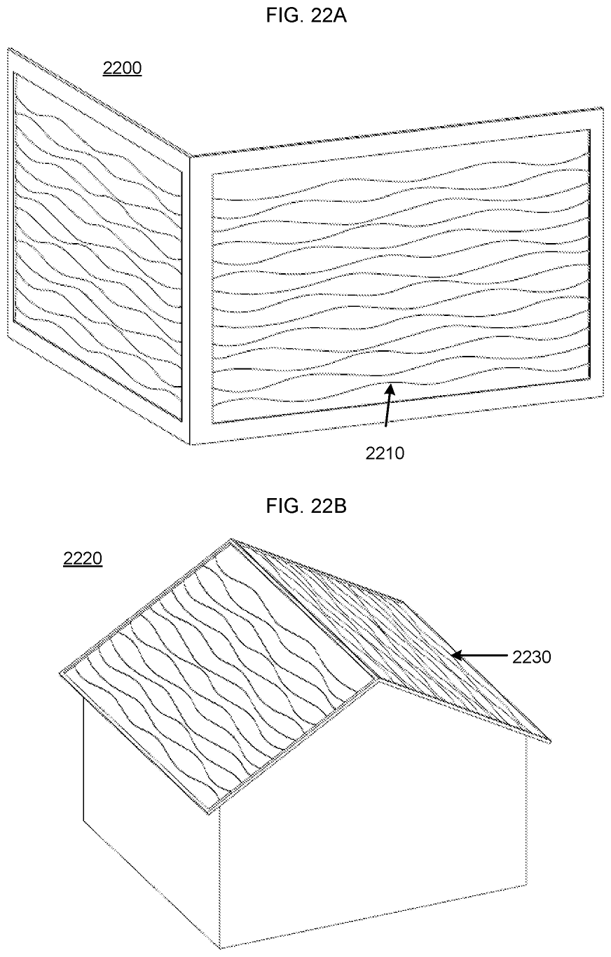

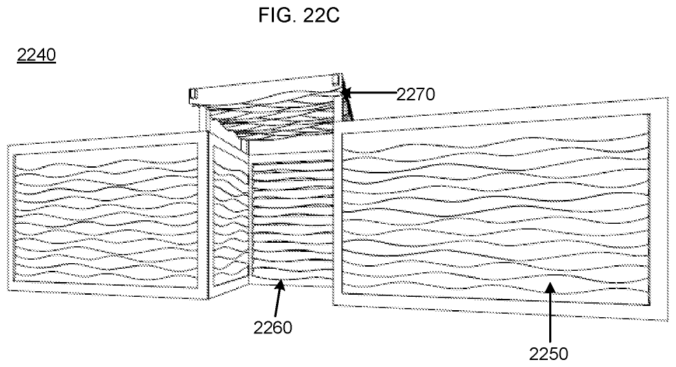

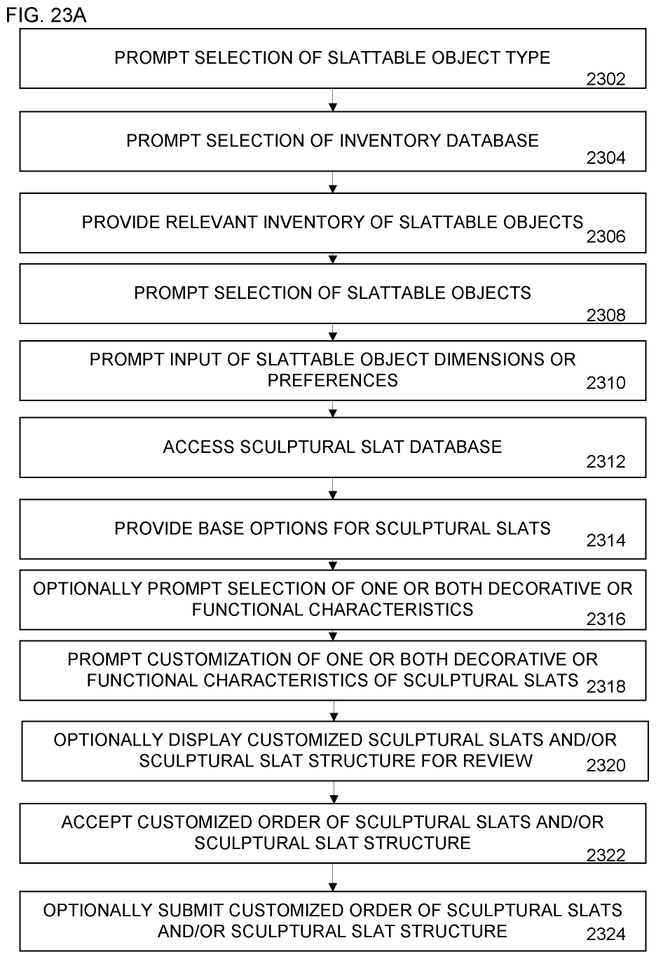

Referring now to FIGS. 22A-22C, exemplary embodiments of exterior architectural coverings that may use a series of sculptural slats are illustrated, wherein the series of sculptural slats have substantially different curvilinear, meandering profiles along their longitudinal ends. Referring now to FIG. 22A, an exemplary lap siding 2200 with a series of curvilinear sculptural slats 2210 is illustrated. Referring now to FIG. 22B, an exemplary set of roof shingles 2220 with a series of curvilinear sculptural slats 2230 is illustrated. Referring now to FIG. 22C, an exemplary exterior installation sculptural slat structure 2240 is illustrated. In some embodiments, the exterior installation sculptural slat structure 2240 may comprise a fence 2250, a pergola 2280, and a gate 2260. In some aspects, alternate outdoor structures may include walls, trellises, arbors, planter boxes, or raised garden boxes, as non-limiting options.

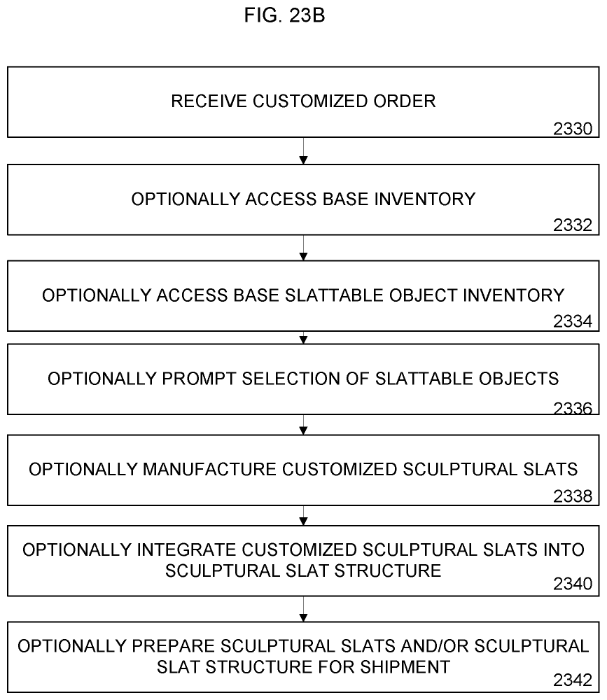

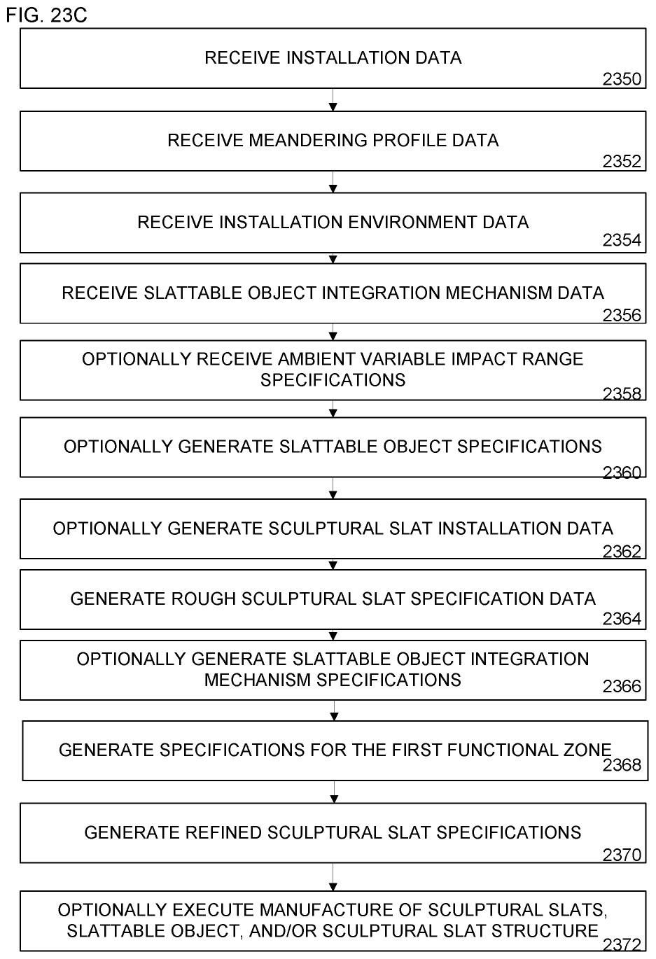

Referring now to FIG. 23A, an exemplary process flowchart for customizing and ordering sculptural slat structures is illustrated. At 2302, selection of a slattable object type may be prompted. At 2304, inventory database may be accessed. In some embodiments, at 2306, relevant base inventory may be accessed. At 2308, selection of a slattable object may be prompted. At 2310, an input for slattable dimensions or preferences may be prompted. At 2312, a sculptural slat database may be accessed. At 2314, pre-designed base options for sculptural slats may be provided. In some aspects, at 2316, a selection of one or both decorative or ambient variable impact may be prompted. At 2318, customization of one or both decorative or ambient variable impact of sculptural slats may be prompted. In some implementations, at 2320, a customized sculptural slat may be displayed using images, three-dimensional models, augmented reality, virtual reality, or some other means. At 2322, a customized order of sculptural slats may be accepted. In some embodiments, at 2324, a customized order of sculptural slats may be submitted. For example, the orders may be submitted to a manufacturer, installer, or local printer, such as a 3D printer, home printer, or retail printer.

Referring now to FIG. 23B, an exemplary process flowchart for manufacturing customized sculptural slats is illustrated. At 2330, a customized order may be received, such as from specifications submitted by a retailer, consumer, or other party. In some aspects, at 2332, a base inventory may be accessed, and, at 2334, a base slattable object may be selected. In some implementations, at 2336, a base slat may be selected, wherein the base slat may be modified by additive, subtractive, or adhesion techniques. At 2338, a customized sculptural slat may be manufactured, wherein the manufacturing may utilize raw or base materials, modifiable base slats, such as those selected at 2340, or combinations thereof In some embodiments, at 2340, a customized sculptural slat may be integrated into a slattable object, such as those selected at 2334.

For example, at 2340, customized sculptural slats may be integrated into a window covering, such as into interior shutters, creating a new sculptural slat structure. In some aspects, at 2342, the shipment of one or more sculptural slats or slattable objects may be prepared.

Referring now to FIG. 23C, an exemplary process flowchart for generating specifications for manufacturing customized sculptural slats is illustrated. At 2350, installation data may be received. In some aspects, installation data may comprise height data, width data, and depth data related to the installation site. At 2352, meandering profile data may be received. At 2354, installation environment data may be received, such as related to a first and second environment, wherein the sculptural slat structure is configured to be installed between the first environment and the second environment. As an illustrative example, the first environment may be an exterior environment, and the second environment may be an interior environment, wherein the sculptural slat structure may be installed over a window that may separate the exterior and interior environment.

At 2356, integration mechanism data may be received. In some aspects, at 2358, ambient variable impact range specifications may be received, which may define a potential range of ambient variable impact based on one or more of the installation data, sculptural slat material, the installation environment data, and sculptural edge data, wherein the ambient variable impact range specifications at least partially define the slattable integration mechanism specifications and refined sculptural slat specifications. In some embodiments, at 2360, slattable object specifications may be generated, which may include, for example, a slattable object type, height data, depth data, and width data, wherein the slattable object specifications are based at least in part on one or more of the installation data, meandering profile data, and generated rough sculptural slat specifications.

In some implementations, at 2362, sculptural slat installation data may be generated, such as, for example, a quantity of sculptural slats and alignment specifications defining at least installation distance between adjacent sculptural slats and installation distance between sculptural slats and the slattable object. At 2364, rough sculptural slat specification data may be generated, which may include, for example, sculptural slat width data and sculptural meandering profile design. In some aspects, at 2366, integration mechanism specifications may be generated. At 2368, specifications for the first functional zone may be generated, which may include, for example, comprising slattable object integration feature specifications and alignment specifications, wherein alignment specifications may define the first latitudinal end, wherein adjacent sculptural slats are aligned at the first latitudinal end when installed.

At 2380, refined sculptural slat specifications may be generated that may define augmentation of the first functional zone and the second functional zone, wherein the refined sculptural slat specifications may be based at least in part on at least one ambient variable, the integration mechanism, installation environment data, and the rough sculptural slat specification data. In some embodiments, at 2382, the manufacturing of one or more of the sculptural slat, the slattable object, the sculptural slat structure, or integration mechanism.

In some embodiments, a user accesses a database that generates available stock in real time. A user may access this database from smart devices, work stations, retail spaces, internet-connected devices, and/or devices connected to a server that generates real-time stock. From this database, a user may customize the overall shape of a sculptural slat structure, whether that be the design of the sculptural slat design or the structure itself, by manipulating the generated information either in real-time, through a series of options provided by a display or menu, or through a pre-programmed or pre-generated identification code. For example, an identification code may be generated at a retail location after a user looks at a display with samples, chooses how a sculptural slat structure should look, and then receives a print-out or follow-up notification, which may be by electronic means, to then revisit and order their design at a later time. A retail location may also ping a server to see whether they have any items currently in stock to accurately estimate availability.

In some implementations, a user may select from a set of default or pre-created sculptural slat structures with accompanying designs already in existence, or access a pool of content created by other users to see if a user also wants to order that creation. In some aspects, a user may upload a graphic to apply to a design that they may then order. In some embodiments, a user may create, customize, or choose from single-slat or multi-piece sculptural slat designs. In some implementations, a user may create, customize, or choose from silk screen or ink printed patterns. In some embodiments, a user may create, customize, or choose from cut, scored, or engraved patterns. In some aspects, a user may create, customize, or choose from colored edges to apply to a design. In some implementations, a user may apply a pattern to a sculptural slat structure, which they can create or customize, or choose from pre-existing patterns, such as dots, waves, diagonals, dunes or zigzags. In some embodiments, a user may order replacement sculptural slats for designs they previously ordered to replace a prior sculptural slat or to expand the functionality depending on the sculptural slat structure previously ordered.

In some embodiments, a user may create, customize, or choose from a variety of materials to apply to their sculptural slat structure creation. In some implementations, a database a user is accessing may advise the best combination or design based on the materials a user chooses from. In some implementations, a database a user is accessing may advise the best combination or design based on the patterns a user chooses from. In some implementations, a database a user is accessing may advise the best combination or design based on the sculptural shape a user chooses from. In some implementations, a database a user is accessing may advise the best combination or design based on the slatted object a user chooses from. In some aspects, a database may limit the choices a user may choose from based on their selections, such as if a metal would not pair with a certain color scheme due to unavailability or incompatibility.

In some implementations, a user may generate a digital visualization of their selection in real-time, using virtual or augmented reality to help the user display, design, and experience their selection. For example, a user may be at a retail location and choose a design for a sculptural slat structure. The design selected for the sculptural slat structure may then be digitally displayed, from either a kiosk within the retail location or from a portable device with access to that functionality, and have the designs digitally overlaid on physical models within the location. Separately, in some embodiments, this digital visualization can be displayed anywhere in a three-dimensional representation, wherein a user may appraise and investigate the design, functionality, shape, or pattern of the sculptural slat structure that they have chosen.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multi-tasking and parallel processing may be advantageous. Nevertheless, it will be understood that various modifications may be made without departing from the spirit and scope of the claimed disclosure.

What is claimed is:

1. A sculptural slat comprising:
a first longitudinal end comprising at least one meandering profile;
a first latitudinal end, wherein the first latitudinal end is connected perpendicularly to the first longitudinal end;
a second longitudinal end, wherein the second longitudinal end is connected perpendicularly to the first latitudinal end and is distally located from the first longitudinal end; and
a second latitudinal end, wherein the second latitudinal end is connected perpendicularly to both the second longitudinal end and the first longitudinal end at opposing ends of the second latitudinal end.

2. The sculptural slat of claim 1, wherein the sculptural slat comprises at least one integration mechanism.

3. The sculptural slat of claim 1, wherein the sculptural slat comprises two or more layers.

4. The sculptural slat of claim 1, wherein incongruent ends of the top and bottom planar surface connect at the first longitudinal end to form a meandering profile with variable thickness.

5. The sculptural slat of claim 4, wherein the surface of the sculptural slat is asymmetric in three dimensions.

6. The sculptural slat of claim 1, wherein the sculptural slat comprises a variable thickness.

7. The sculptural slat of claim 6, wherein the sculptural slat comprises one or more layers that form the variable thickness.

8. The sculptural slat of claim 1, wherein the sculptural slat is configured to insert onto a traditional slattable structure.

9. A sculptural slat structure comprising:
a slattable object;
a plurality of sculptural slats inserted in parallel within the slattable object, wherein each sculptural slat comprises:
a first longitudinal end comprising at least one meandering profile;
a first latitudinal end, wherein the first latitudinal end is connected perpendicularly to the first longitudinal end;
a second longitudinal end, wherein the second longitudinal end is connected perpendicularly to the first latitudinal end and is distally located from the first longitudinal end; and
a second latitudinal end, wherein the second latitudinal end is connected perpendicularly to both the second longitudinal end and the first longitudinal end at opposing ends of the second latitudinal end; and
an integration mechanism connecting the plurality of sculptural slats to the slattable object.

10. The sculptural slat structure of claim 9, wherein the plurality of sculptural slats comprises asymmetric meandering profiles of different lengths.

11. The plurality of sculptural slats of claim 10, wherein the plurality of sculptural slats overlaps asymmetrically.

12. The sculptural slat structure of claim 9, wherein each of the plurality of sculptural slats comprise a light source.

13. The sculptural slat structure of claim 9, wherein each of the at least one meandering profiles comprises a curvilinear, orthogonal, or rectilinear profile.

14. The sculptural slat structure of claim 9, wherein the plurality of sculptural slats comprises two or more asymmetric sculptural slat designs.

15. The sculptural slat structure of claim 9, wherein each of the at least one meandering profiles comprises a unique pattern.

16. The sculptural slat structure of claim 9, wherein each of the plurality of sculptural slats are configured for a plurality of orientations within the slattable object.

17. The sculptural slat structure of claim 16, wherein the plurality of orientations are controllable through the integration mechanism.

18. The sculptural slat structure of claim 16, wherein the plurality of orientations creates a plurality of ambient variable impact.

19. The sculptural slat structure of claim 9, wherein each of the plurality of sculptural slats comprises variable thickness.

20. The sculptural slat structure of claim 9, wherein each of the second longitudinal end comprises at least a second meandering profile.
